(19) United States
(12) Patent Application Publication
(10) Pub. No.: US 2016/0361713 A1
(43) Pub. Date: Dec. 15, 2016

(54) METHODS FOR PRODUCING OXYGEN AND HYDROGEN FROM WATER USING AN IRIDIUM ORGANOMETALLIC CATALYST DEPOSITED ON A TITANIUM DIOXIDE CATALYST

(71) Applicant: SABIC Global Technologies B.V., Bergen op Zoom (NL)

(72) Inventors: Gabriele Pastori, Perugia (IT); Alceo Macchioni, Perugia (IT); Hicham Idriss, Thuwal (SA)

(21) Appl. No.: 15/176,908

(22) Filed: Jun. 8, 2016

Related U.S. Application Data
(60) Provisional application No. 62/175,579, filed on Jun. 15, 2015.

(51) Int. Cl. B01J 31/38; B01J 35/00; B01J 21/06; B01J 31/22; C01B 13/02; C01B 3/04

(52) U.S. Cl. CPC B01J 31/38; C01B 13/0207; C01B 3/042; B01J 21/063; B01J 31/2295; B01J 35/004; B01J 2231/005; B01J 2531/827; B01J 2531/007

(57) ABSTRACT

Disclosed is a method for producing oxygen (O₂) and hydrogen (H₂) from water, the method comprising (a) obtaining a composition comprising (i) a hybrid catalyst comprising an organo-iridium catalyst deposited on the surface of a titanium dioxide catalyst, and (ii) an aqueous solution having a buffer or having a base wherein the base is present in the aqueous solution in an amount at least 4 times equivalent with respect to the organo-iridium catalyst present on the hybrid catalyst, and (b) exposing the composition to light to produce O₂ and H₂ from water molecules in the aqueous solution.

### CROSS REFERENCE TO RELATED APPLICATIONS

This application claims the benefit of priority of U.S. Provisional Patent Application No. 62/175,579, filed Jun. 15, 2015, which is hereby incorporated by reference in its entirety.

### BACKGROUND OF THE INVENTION

A. Field of the Invention

The invention generally concerns the production of oxygen and hydrogen from water using a hybrid catalyst. The hybrid catalyst includes an organo-iridium compound deposited on the surface of a metal/titanium dioxide semiconductor photocatalyst and the use of an aqueous solution.

B. Description of Related Art

Hydrogen production from water offers enormous potential benefits for the energy sector, the environment, and the chemical industry. While methods currently exist for producing hydrogen and oxygen from water, many of these methods can be costly, inefficient, or unstable. For instance, photoelectrochemical (PEC) water splitting requires an external bias or voltage and a costly electrode (e.g., Pt-based).

With respect to photocatalytic electrolysis of water from light sources, while many advances have been achieved in this area, most materials are either unstable under realistic water splitting conditions or require considerable amounts of other components (e.g., large amounts of sacrificial hole or electron scavengers) to work, thereby offsetting any gained benefits. For instance, in heterogeneous photo-catalytic reactions with semiconductors, organic compounds as sacrificial agents, are often used to accelerate hydrogen production. This is because oxygen ions electron injection into the valence band of the semiconductor (oxidation) is slow while that of alcohols (for example) is fast.

Much of the recent work has been devoted to the use of molecular catalysts (mostly based on organometallic compounds) for water oxidation. One of the drawbacks of molecular catalysis, however, is the need to use a homogenous medium, thereby decreasing the likelihood of their efficient utilization, recyclability and scalability. Another drawback is the need to combine the molecular catalyst with a hydrogen evolution catalyst that is typically present in another compartment, such as in the case of electro- and photoelectro-catalysis.

Several attempts have been made to put an organometallic catalyst on top of the semiconductor photo-catalyst with the ultimate goal to make both reactions (hydrogen and oxygen evolutions) simultaneously on adjacent sites. These attempts have been largely unsuccessful. For instance, additional materials (e.g., scavenger molecules) and the use of external biases have made the processes inefficient and difficult to scale-up for mass hydrogen and oxygen production. By way of example, U.S. Patent Application No. 2015/0021194 to Sheehan et al. describes solution-phase or surface immobilized electrocatalysts based on iridium coordination compounds which self-assemble upon chemical oxidation of suitable precursors. Sheehan et al. also uses an electrode for the water oxidation process. Similarly, International Patent Application Publication No. 2012122605 to Lo describes a cyclometalated iridium based complex for use as an electrode in water splitting reactions. Savini et al., in ACS Catalysis, 2015, Vol. 5, pp. 264-271 describes the use of an Ir[(HEDTA)Cl]Na immobilized on rutile titanium dioxide with cerium ammonium nitrate as the sacrificial oxidant in water splitting reactions carried out at pH 1 by HNO₃.

### SUMMARY OF THE INVENTION

A discovery has been made that provides a solution to the aforementioned problems and inefficiencies associated with the generation of hydrogen and oxygen from water. The discovery is premised on the use of (1) a hybrid catalyst having an organo-iridium catalyst deposited on the surface of a metal/titanium dioxide catalyst with (2) an aqueous solution having a buffer or having a base wherein the base is present in the aqueous solution in an amount at least 4 times equivalent with respect to the organo-iridium catalyst present on the hybrid catalyst. The pH of the aqueous solution can be from 2 to 14, preferably, 3 to 12, more preferably 5 to 10, and most preferably 7 to 8. In particularly preferred embodiments, the pH can be slightly basic (pH of about 7≦8). The pH can be obtained or maintained by using a buffer. Alternatively, the pH can be obtained or maintained by adding a base to the aqueous solution in an amount of at least four times equivalent with respect to the organo-iridium catalyst concentration present on the hybrid catalyst. As illustrated in non-limiting embodiments in the examples, it was discovered that adding up to four equivalents of base in the aqueous solution failed to improve the performance of the hybrid catalyst. However, the addition of at least 4 times to 40 times equivalent, preferably 6 times to 32 times equivalent, and most preferably 8 times to 20 times equivalent of base with respect to the organo-iridium catalyst concentration present on the hybrid catalyst or maintaining the pH at neutral/slightly basic values by using a buffer resulted in a dramatic and unexpected enhancement of catalytic activity (e.g., up to one order of magnitude higher in catalytic activity). Still further, a critical range of 6 to about 32 times equivalents, and most preferably about 8 to 20 times equivalents can be seen from the data. It was also discovered that the hybrid catalysts of the present invention are stable across all pH ranges, particularly under high pH conditions. Even further, while sacrificial oxidants can be used with the aqueous solutions of the present invention, it is believed that the process could be used with limited amounts or even in the absence of sacrificial oxidants in the aqueous solution.

In one particular aspect of the present invention, there is disclosed method for producing hydrogen (H₂) gas and oxygen (O₂) gas. The method can include: (a) obtaining a composition and conducting the oxidation reaction to produce O₂ and (b) exposing the composition to light to produce O₂ and H₂ from water molecules in the aqueous solution. The light can be sunlight or artificial light (e.g., light having both ultraviolet and visible light radiation or any light that can excite the semiconductor photocatalyst), or a combination thereof. The composition can include (i) a hybrid catalyst comprising an iridium containing catalyst deposited on the surface of a titanium dioxide catalyst and (ii) an aqueous solution having a buffer or having a base wherein the base is present in the aqueous solution in an amount at least 4 times equivalent with respect to the organo-iridium catalyst present on the hybrid catalyst. The pH of the aqueous solution can be from 2 to 14, preferably, 3 to 12, more preferably 5 to 10, and most preferably 7 to 8. The temperature of the composition in step (b) can range from 10° C. to 70° C. In some preferred aspects, the pH can be neutral/slightly basic and maintained with a buffer (e.g., NaH₂PO₄/0.2 M Na₂HPO₄ or sodium carbonate/hexafluorosilicate buffer (NaHCO₃/Na₂SiF₆)). Alternatively, the aqueous solution can include a base in an amount of at least 4 times equivalent with respect to the organo-iridium catalyst concentration present on the hybrid catalyst and also have a neutral or slightly basic pH. In some embodiments, the amount of base present in the aqueous solution is at least 4 times to 40 times equivalent, preferably 6 times to 32 times equivalent, and most preferably 8 times to 20 times equivalent with respect to the organo-iridium catalyst concentration present on the hybrid catalyst. In some embodiments, the base can include alkali and alkaline earth metal salts of hydroxide ion, with KOH being preferred. In some embodiments, the aqueous composition can or may not include a sacrificial oxidant. Non-limiting examples of sacrificial oxidants include cerium ammonium nitrate (CAN) or sodium periodate (NaIO₄) or a photosensitizer/electron acceptor system such as ruthenium(II)-tris-2,2′-bipyridine/sodium persulfate ([Ru(bipy)]²⁺/Na₂S₂O₈). Notably, the hybrid catalyst can be particulates that are homogenously or heterogeneously dispersed in the aqueous solution and have the same activity as its homogeneous counterpart, notably, the organo-iridium catalyst. As noted above, it was unexpectedly found that the activities of the hybrid catalyst was enhanced at slightly basic conditions or in the presence of at least 4 equivalents of base vis-à-vis the organo-iridium catalyst. The hybrid catalyst has a turnover number of at least 1000, 1500, 2000, 3000, or preferably from 1000 to 3000, or more preferably 1500 to 3000, and has a turnover frequency from 40 to 90 min⁻¹. In a particular aspect of the invention, the organo-iridium catalyst can be a Klaüi-type compound having the following structure:

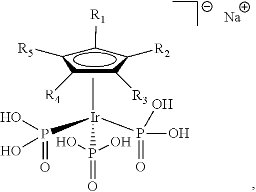

where R¹ to R⁵ are the same or different and are H, C₁ to C₄ alkyl moieties, or a combination thereof, preferably R¹ to R⁵ are methyl moieties. In a particular aspect, the organo-iridium catalyst has the following structure:

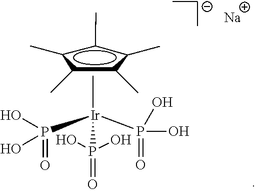

The titanium dioxide catalyst portion of the hybrid catalyst can be a metal containing TiO₂ catalyst (metal/TiO₂), where the metal is from Groups 8-11 of the Periodic Table such as silver (Ag), palladium (Pd), platinum (Pt), gold (Au), nickel (Ni), cobalt (Co), Rhodium (Rh), Ruthenium (Ru), Iridium (Ir) and copper (Cu) In some embodiments, the organo-iridium hybrid catalyst directly contacts the metal nanoparticles. The titanium dioxide catalyst can include anatase, rutile, or brookite, or any combination thereof. In some embodiments, the titanium dioxide support is single phase anatase or single phase rutile. The titanium dioxide catalyst can also include a mixture of anatase and rutile and the ratio of anatase to rutile ranges from 1.5:1 to 10:1, preferably 3:1 to 8:1, and most preferably from 5:1 to 7:1. The titanium dioxide catalyst can be a mixed phase of anatase and rutile. The titanium dioxide particles can have a mean particle size of less than 100 nanometers (nm), less than 50 nm, less than 40 nm, less than 30 nm, less than 20 nm, or preferably, 5 to 30 nm, or most preferably 5 to 20 nm. In some embodiments, the composition is comprised in an electrolytic cell having an anode and a cathode, wherein a voltage between the anode and cathode is produced and water molecules are split to produce O₂ and H₂. In some aspects of the invention, an external bias is not used to produce O₂ and H₂ gas.

In another aspect of the invention, a hybrid catalyst is described. The hybrid catalyst can include an organo-iridium catalyst deposited on the surface of a titanium dioxide catalyst, wherein the organo-iridium catalyst has the following structure:

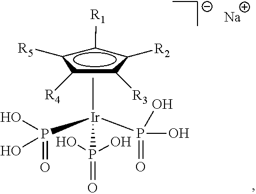

where R¹ to R⁵ are the same or different and are H, C₁ to C₄ alkyl moieties, or a combination thereof, preferably R¹ to R⁵ are methyl moieties. The titanium dioxide catalyst portion of the hybrid catalyst can be a metal containing TiO₂ catalyst (metal/TiO₂), where the metal is from Groups 8-11 of the Periodic Table such as silver (Ag), palladium (Pd), platinum (Pt), gold (Au), nickel (Ni), cobalt (Co), Rhodium (Rh), Ruthenium (Ru), Iridium (Ir) and copper (Cu) nanoparticles, or any combination thereof. In some embodiments, the organo-iridium catalyst directly contacts the metal nanoparticles. The titanium dioxide catalyst can include anatase, rutile, or brookite, or any combination thereof. In some embodiments, the titanium dioxide support is single phase anatase or single phase rutile. The titanium dioxide catalyst can also include a mixture of anatase and rutile and the ratio of anatase to rutile ranges from 1.5:1 to 10:1, preferably 3:1 to 8:1, and most preferably from 5:1 to 7:1. The titanium dioxide catalyst can be a mixed phase of anatase and rutile. The titanium dioxide particles can have a mean particle size of less than 100 nanometers (nm), less than 50 nm, less than 40 nm, less than 30 nm, less than 20 nm, or preferably, 5 to 30 nm, or most preferably 5 to 20 nm. The hybrid catalyst has a turnover number of at least 1000, 1500, 2000, 3000, or preferably from 1000 to 3000, or more preferably 1500 to 3000, and has a turnover frequency from 30 to 90 min⁻¹.

In one aspect of the invention, a composition capable of producing oxygen (O₂) and hydrogen (H₂) from water is described. The composition can include (a) a hybrid catalyst comprising an organo-iridium catalyst deposited on the surface of a titanium dioxide catalyst; and (b) an aqueous solution having a buffer or having a base wherein the base is present in the aqueous solution in an amount at least 4 times equivalent with respect to the organo-iridium catalyst concentration present on the hybrid catalyst. The pH of the aqueous solution can be from 2 to 14, preferably, 3 to 12, more preferably 5 to 10, and most preferably 7 to 8. The amount of base present in the aqueous solution can be at least 4 times to 40 times equivalent, preferably 6 times to 32 times equivalent, and most preferably 8 times to 20 times equivalent with respect to the iridium concentration present on the hybrid catalyst. In preferred aspects, the base in the composition is capable of adjusting the pH from acidic to a basic pH of ≦8, preferably 7≦8. A non-limiting example of a base is potassium hydroxide. The hybrid catalyst can be any of the hybrid catalysts described throughout the specification.

In certain embodiments of the present invention a system for producing oxygen (O₂) and hydrogen (H₂) from water is described. The system can include (a) a container comprising the composition of any one of the compositions of the present invention described throughout the specification; and (in the case of the hybrid system) (b) a light source with energy and spectral distribution equivalent to that of the sun for exposing the composition to light when hydrogen and oxygen are targeted. The light source can be sunlight or an artificial light source having the equivalent energy of the sun, or a combination thereof. The container can include a transparent portion, an opaque portion, or both. In some aspects, the system can include an electrolytic cell having an anode and a cathode. In the systems and methods described herein, the system and/or methods do not include an external bias to produce H₂ gas.

In the context of the present invention, sixty-six (66) embodiments are described. Embodiment 1 includes a method for producing oxygen (O₂) and hydrogen (H₂) from water The method can include (a) obtaining a composition comprising: (i) a hybrid catalyst including an organo-iridium catalyst deposited on the surface of a titanium dioxide catalyst; and (ii) an aqueous solution having a buffer or having a base wherein the base is present in the aqueous solution in an amount at least 4 times equivalent with respect to the organo-iridium catalyst present on the hybrid catalyst; and (b) exposing the composition to light to produce O₂ and H₂ from water molecules in the aqueous solution. Embodiment 2 is the method of embodiment 1, wherein the aqueous solution has a base present in the aqueous solution in an amount at least 4 times to 40 times equivalent, preferably 6 times to 32 times equivalent, and most preferably 8 times to 20 times equivalent with respect to the organo-iridium catalyst present on the hybrid catalyst. Embodiment 3 is the method of any one of embodiments 1 to 2, wherein the pH of the aqueous solution is 2 to 14, preferably, 3 to 12, more preferably 5 to 10, and most preferably 7 to 8. Embodiment 4 is the method of any one of embodiments 1 to 3, wherein the aqueous solution does not include a sacrificial oxidant. Embodiment 5 is the method of any one of embodiments 1 to 3, wherein the aqueous solution further includes a sacrificial oxidant. Embodiment 6 is the method of any one of embodiments 4 to 5, wherein the sacrificial oxidant is cerium ammonium nitrate (CAN), sodium periodate (NaIO₄), or sodium persulfate/ruthenium(II)-tris-2,2′-bipyridine (Na₂S₂O₈/[Ru(bipy)]²⁺). Embodiment 7 is the method of any one of embodiments 1 to 6, wherein the hybrid catalyst is heterogeneously dispersed in the aqueous solution. Embodiment 8 is the method of any one of embodiments 1 to 6, wherein the hybrid catalyst is partially or fully solubilized in the aqueous solution. Embodiment 9 is the method of any one of embodiments 1 to 8, wherein the organo-iridium catalyst is a Klaüi-type compound. Embodiment 10 is the method of embodiment 9, wherein the Klaüi-type compound has the following structure:

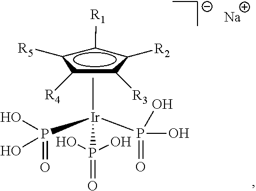

where R¹ to R⁵ the same or different and is H, or a C₁ to C₄ alkyl moieties or a combination thereof, preferably R¹ to R⁵ are methyl moieties. Embodiment 11 is the method of embodiment 10, wherein each of R¹ to R⁵ is CH₃. Embodiment 12 is the method of any one of embodiments 1 to 11, wherein the titanium dioxide catalyst is a metal containing TiO₂ catalyst (metal/TiO₂), where the metal is from Groups 8-11 of the Periodic Table. Embodiment 13 is the method of embodiment 12, wherein the metal is silver (Ag), palladium (Pd), platinum (Pt), gold (Au), nickel (Ni), cobalt (Co), Rhodium (Rh), Ruthenium (Ru), Iridium (Ir), or copper (Cu) nanoparticles, or any combination thereof. Embodiment 14 is the method of any one of embodiments 12 to 13, wherein the organo-iridium catalyst directly contacts the metal nanoparticles. Embodiment 15 is the method of any one of embodiments 1 to 14, wherein the titanium dioxide catalyst includes anatase, rutile, or brookite, or any combination thereof. Embodiment 16 is the method of embodiment 15, wherein the titanium dioxide support comprises single phase anatase or single phase rutile. Embodiment 17 is the method of embodiment 16, wherein the titanium dioxide catalyst comprises a mixture of anatase and rutile. Embodiment 18 is the method of embodiment 17, wherein the ratio of anatase to rutile ranges from 1.5:1 to 10:1, preferably 3:1 to 8:1, and most preferably from 5:1 to 7:1. Embodiment 19 is the method of any one of embodiments 17 to 18, wherein the titanium dioxide catalyst is a mixed phase of anatase and rutile. Embodiment 20 is the method of embodiments 1 to 19, wherein the hybrid catalyst is in particulate form. Embodiment 21 is the method of embodiment 20, wherein the hybrid catalyst includes titanium dioxide particles having a mean particle size of less than 100 nanometers (nm), less than 50 nm, less than 40 nm, less than 30 nm, less than 20 nm, or preferably, 5 to 30 nm, or most preferably 5 to 20 nm. Embodiment 22 is the method of any one of embodiments 1 to 21, wherein the composition is included in an electrolytic cell having an anode and a cathode, wherein a voltage between the anode and cathode is produced and water molecules are split to produce O₂ and H₂. Embodiment 23 is the method of any one of embodiments 1 to 22, wherein an external bias is not used to produce O₂ and H₂ gas. Embodiment 24 is the method of any one of embodiments 1 to 23, wherein the hybrid catalyst has a turnover number of at least 1000, 1500, 2000, 3000, or preferably from 1000 to 3000, or more preferably 1500 to 3000, and has a turnover frequency from 40 to 90 min⁻¹. Embodiment 25 is the method of any one of embodiments 1 to 24, wherein the temperature of the composition in step (b) ranges from 10° C. to 70° C. Embodiment 26 is the method of any one of embodiments 1 to 25, wherein the light is from sunlight or an artificial light source comprising ultraviolet and visible radiations, or a combination thereof

Embodiment 27 includes a hybrid catalyst. The hybrid catalyst can include an organo-iridium catalyst deposited on the surface of a titanium dioxide catalyst, wherein the organo-iridium catalyst has the following structure:

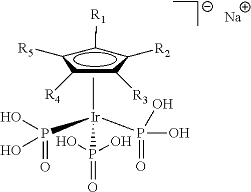

where R¹ to R⁵ are the same or different and are H, C₁ to C₄ alkyl moieties, or a combination thereof, preferably R¹ to R⁵ are methyl moieties. Embodiment 28 is the hybrid catalyst of embodiment 27, wherein each of R¹ to R⁵ is CH₃. Embodiment 29 is the hybrid catalyst of any one of embodiments 27 to 28, wherein the titanium dioxide catalyst is a metal containing TiO₂ catalyst (metal/TiO₂), where the metal is from Groups 8-11 of the Periodic Table. Embodiment 30 is the hybrid catalyst of embodiment 29, wherein the metal is silver (Ag), palladium (Pd), platinum (Pt), gold (Au), nickel (Ni), cobalt (Co), Rhodium (Rh), Ruthenium (Ru), Iridium (Ir), or copper (Cu) nanoparticles, or any combination thereof. Embodiment 31 is the hybrid catalyst of any one of embodiments 29 to 30, wherein the organo-iridium catalyst directly contacts the metal nanoparticles. Embodiment 32 is the hybrid catalyst of any one of embodiments 27 to 31, wherein the titanium dioxide catalyst includes anatase, rutile, or brookite, or any combination thereof. Embodiment 33 is the hybrid catalyst of embodiment 32, wherein the titanium dioxide support comprises single phase anatase or single phase rutile. Embodiment 34 is the hybrid catalyst of embodiment 33, wherein the titanium dioxide catalyst comprises a mixture of anatase and rutile. Embodiment 35 is the hybrid catalyst of embodiment 34, wherein the ratio of anatase to rutile ranges from 1.5:1 to 10:1, preferably 3:1 to 8:1, and most preferably from 5:1 to 7:1. Embodiment 36 is the hybrid catalyst of any one of embodiments 34 to 35, wherein the titanium dioxide catalyst is a mixed phase of anatase and rutile. Embodiment 37 is the hybrid catalyst of any one of embodiments 27 to 36, wherein the hybrid catalyst is in particulate form. Embodiment 38 is the hybrid catalyst of embodiment 37, wherein the hybrid catalyst includes titanium dioxide particles having a mean particle size of less than 100 nanometers (nm), less than 50 nm, less than 40 nm, less than 30 nm, less than 20 nm, or preferably, 5 to 30 nm, or most preferably 5 to 20 nm. Embodiment 39 is the hybrid catalyst of any one of embodiments 27 to 38, wherein the hybrid catalyst has a turnover number of at least 1000, 1500, 2000, 3000, or preferably from 1000 to 3000, or more preferably 1500 to 3000, during use, and has a turnover frequency from 40 to 90 min⁻¹.

Embodiment 40 includes a composition capable of producing oxygen (O₂) and hydrogen (H₂) from water. The composition can include (a) a hybrid catalyst comprising an organo-iridium catalyst deposited on the surface of a titanium dioxide catalyst; and (b) an aqueous solution having a buffer or having a base wherein the base is present in the aqueous solution in an amount at least 4 times equivalent with respect to the organo-iridium catalyst present on the hybrid catalyst. Embodiment 41 is the composition of embodiment 40, wherein the aqueous solution has a base present in the aqueous solution in an amount at least 4 times to 40 times equivalent, preferably 6 times to 32 times equivalent, and most preferably 8 times to 20 times equivalent with respect to the organo-iridium catalyst present on the hybrid catalyst. Embodiment 42 is the composition of any one of embodiments 40 to 41, wherein the pH of the aqueous solution is 2 to 14, preferably, 3 to 12, more preferably 5 to 10, and most preferably 7 to 8. Embodiment 43 is the composition of embodiment 42, wherein the base is potassium hydroxide. Embodiment 44 is the composition of any one of embodiments 40 to 43, wherein the aqueous solution does not include a sacrificial oxidant. Embodiment 45 is the composition of any one of embodiments 40 to 43, wherein the aqueous solution further includes a sacrificial oxidant. Embodiment 46 is the composition of any one of embodiments 44 to 45, wherein the sacrificial oxidant is cerium ammonium nitrate (CAN), sodium periodate (NaIO₄), or sodium persulfate/ruthenium(II)-tris-2,2′-bipyridine (Na₂S₂O₈/[Ru(bipy)]²⁺). Embodiment 47 is the composition of any one of embodiments 40 to 46, wherein the hybrid catalyst is heterogeneously dispersed in the aqueous solution. Embodiment 48 is the composition of any one of embodiments 40 to 47, wherein the organo-iridium catalyst is a Klaüi-type compound. Embodiment 49 is the composition of embodiment 48, wherein the Klaüi-type compound has the following structure:

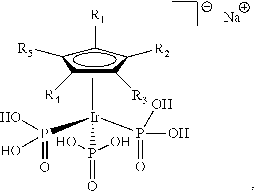

where R¹ to R⁵ are the same or different and are H, C₁ to C₄ alkyl moieties, or a combination thereof, preferably R¹ to R⁵ are methyl moieties. Embodiment 50 is the composition of embodiment 49, wherein each of R¹ to R⁵ is CH₃. Embodiment 51 is the composition of any one of embodiments 40 to 49, wherein the titanium dioxide catalyst is a metal containing TiO₂ catalyst (metal/TiO₂), where the metal is from Groups 8-11 of the Periodic Table. Embodiment 52 is the composition of embodiment 51, wherein the metal is silver (Ag), palladium (Pd), platinum (Pt), gold (Au), nickel (Ni), cobalt (Co), Rhodium (Rh), Ruthenium (Ru), Iridium (Ir) or copper (Cu) nanoparticles, or any combination thereof. Embodiment 53 is the composition of any one of embodiments 50 to 52, wherein the organo-iridium catalyst directly contacts the metal nanoparticles. Embodiment 54 is the composition of any one of embodiments 40 to 53, wherein the titanium dioxide catalyst comprises anatase, rutile, or brookite, or any combination thereof. Embodiment 55 is the composition of embodiment 54, wherein the titanium dioxide support includes single phase anatase or single phase rutile. Embodiment 56 is the composition of embodiment 55, wherein the titanium dioxide catalyst includes a mixture of anatase and rutile. Embodiment 57 is the composition of embodiment 56, wherein the ratio of anatase to rutile ranges from 1.5:1 to 10:1, preferably 3:1 to 8:1, and most preferably from 5:1 to 7:1. Embodiment 58 is the composition of any one of embodiments 56 to 57, wherein the titanium dioxide catalyst is a mixed phase of anatase and rutile. Embodiment 59 is the composition of any one of embodiments 40 to 58, wherein the hybrid catalyst is in particulate form. Embodiment 60 is the composition of embodiment 59, wherein the hybrid catalyst includes titanium dioxide particles having a mean particle size of less than 100 nanometers (nm), less than 50 nm, less than 40 nm, less than 30 nm, less than 20 nm, or preferably, 5 to 30 nm, or most preferably 5 to 20 nm.

Embodiment 61 includes a system for producing oxygen (O₂) and hydrogen (H₂) from water. The system can include (a) a container including the composition of any one of claims 40 to 60; and (b) a light source with energy equivalent to that of the sun for exposing the composition to light. Embodiment 62 is the system of embodiment 61, wherein the light source is sunlight or an artificial light source, or a combination thereof. Embodiment 63 is the system of any one of embodiments 61 to 62, wherein the container includes a transparent portion. Embodiment 64 is the system of any one of embodiments 61 to 63, wherein the container includes an opaque portion. Embodiment 65 is the system of any one of embodiments 61 to 64, further comprising an electrolytic cell having an anode and a cathode. Embodiment 66 is the system of any one of embodiments 61 to 64, wherein the system does not include an external bias to produce H₂ gas.

The term “dative bonding” refers to a bond in which both electrons come from the same atom.

The term “heterogeneous”, as used herein, refers to the form of catalysis where the phase of the catalyst differs from that of the reactants.

The term “homogeneous”, as used herein, means the catalyst is soluble (i.e., same phase as the reactants) in the reaction solution.

The phrase “polyprotic” refers to an acid or ligand that is capable of losing more than a single proton per molecule in an acid-base reaction. For example, —PO(OH)₂ is a diprotic ligand.

The phrase “equivalents of base” refers to the amount of base required to remove protons from the polyprotic acid or ligand. For example, 2 equivalents of base means that a compound has 2 protons that are capable of being removed in an acid-base reaction. Equivalents are determined through known acid-base titrimetric methods. For example, titration of an acid with a base of known concentration.

The phrase “Turn over number” or “TON,” as used herein, means the number of moles of substrate that a mole of catalyst converts in the timeframe of the experiment or before being deactivated. TON is calculated as the number of moles of oxygen, divided by the number of moles of iridium in the catalyst unless otherwise indicated.

The phrase “Turn over frequency” or “TOF,” as used herein, refers to the turnover per unit time under turnover conditions. It is typically expressed in min⁻¹. The TOF can be calculated by linear regression of TON versus time plot in during a specified time (e.g., 10-20 minutes, 20-50 minutes, or 20-40 minutes).

The terms “oxidant” or “sacrificial oxidant”, as used herein, refers to the molecule that is reduced during the reactants oxidation (e.g. water).

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the methods and catalysts of the present invention are their abilities to produce hydrogen and oxygen from water.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of the hybrid catalyst of the present invention.

FIG. 2 is an illustration of a mechanism of action for the hybrid catalyst of the present invention.

FIG. 3 is a schematic of an embodiment of a water-splitting system using the photocatalysts of the invention.

FIG. 3A is an expanded view of photocatalyst in the water-splitting system of FIG. 3.

FIG. 4 is an Oak Ridge Thermal Ellipsoid Plot (ORTEP) view of the organo-iridium catalyst of the present invention.

FIG. 5 is an illustration of the intermolecular hydrogen bonding network in the organo-iridium catalyst of the present invention.

FIG. 6 is a crystal structure of Complex 2 showing the alternating layers of methyl cyclopentadienyl (Cp*) and phosphonic acid moieties.

FIG. 7 is a plot of pH versus volume of 0.01 M NaOH added in mL.

FIG. 8 shows plots of pressure in atmosphere of oxygen versus time in minutes for use of organo-iridium methyl esters and the organo-iridium catalyst of the present invention in the water oxidation reactions.

FIG. 9 shows plots of pressure in atmosphere of oxygen versus time in minutes.

FIG. 10 shows plots of pressure in atmosphere of oxygen versus time for water oxidation reactions using the hybrid catalyst of the present invention and cerium ammonium nitrate (CAN).

FIGS. 11-13 are plots of oxygen pressure in atmosphere versus time in minutes for water oxidation reactions using the hybrid catalyst of the present invention and sodium periodate (NaIO₄).

FIG. 14 shows a plot of moles of produced oxygen versus time in minutes for water photo-oxidation using the organo-iridium catalyst of the present invention and [Ru(bipy)]²⁺/Na₂S₂O₈.

FIG. 15 shows oxygen micromoles versus time in minutes for water photo-oxidation reaction using the hybrid catalyst of the present invention and [Ru(bipy)]²⁺/Na₂S₂O₈.

FIG. 16 shows plots of oxygen pressure in atmosphere versus time in minutes for water oxidation reactions using the organo-iridium catalyst of the present invention, NaIO₄, and various equivalents of potassium hydroxide.

FIGS. 17-18 show plots of oxygen pressure in atmosphere versus time in minutes for water oxidation reactions using the hybrid catalyst of the present invention, NaIO₄, and various equivalents of potassium hydroxide.

FIG. 19 shows plots of oxygen pressure in atmosphere versus time in minutes for water oxidation reactions using the organo-iridium catalyst of the present invention and NaIO₄ in buffered solution at different pH values.

FIG. 20A is a plot of oxygen pressure in atmosphere versus time in minutes for water oxidation reactions using the organo-iridium catalyst of the present invention and NaIO₄ in buffered solution at pH=7.7.

FIG. 20B is a plot of oxygen pressure in atmosphere versus time in minutes for water oxidation reactions using the hybrid catalyst (B) of the present invention and NaIO₄ in buffered solution at pH=7.7.

FIG. 21 shows plots of pressure in atm versus time for the base treated hybrid catalyst of the present invention and the supernatant at pH of 10.

FIG. 22 shows plots of pressure in atm versus time for the base treated catalyst and the supernatant at pH of 14.

FIG. 23 shows plots of oxygen pressure in atmosphere versus time in minutes for the hybrid catalyst, base treated hybrid catalyst, and acid treated hybrid catalyst.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A discovery has been made that provides a solution to the aforementioned problems and inefficiencies associated with the generation of hydrogen and oxygen from water. The discovery is based, in part, on the combination of a hybrid catalyst having an organo-iridium catalyst deposited on the surface of a metal/titanium dioxide catalyst with an aqueous solution having a buffer or having a base wherein the base is present in the aqueous solution in an amount at least 4 times equivalent with respect to the organo-iridium catalyst present on the hybrid catalyst. In certain instances, it was discovered that when the aqueous solution has a pH of 7 to 8, a dramatic and unexpected enhancement of catalytic activity is observed. The pH can be obtained by (1) using a buffer solution (preferably a phosphate buffer solution) or (2) adding at least 4 times to 40 times equivalent, preferably 6 times to 32 times equivalent, and most preferably 8 times to 20 times equivalent of a base in the aqueous solutions of the present invention with respect to the organo-iridium catalyst concentration present on the hybrid catalyst. In particular, and when a base is used, a critical range of 6 to about 32 times equivalents, and most preferably about 8 to 20 times equivalents of base with respect to the organo-iridium catalyst concentration has been discovered. This allows the process to be operated without an external bias and with limited amounts to no sacrificial oxidants if so desired. Water splitting can be described as follow:

2H₂O→O₂+4H⁺+4e⁻ E°=1.23 V vs. NHE (1)

4H⁺+4e⁻→2H₂ E°=0.00 V vs. NHE (2)

2H₂O→2H₂+O₂ E°=1.23 V; ΔG=475 kJ/mol (3)

These and other non-limiting aspects of the present invention are discussed in further detail in the following sections.

### A. Photoactive Catalysts

The hybrid catalyst is a combination of an organo-iridium catalyst and a titanium dioxide catalyst. The organo-iridium catalyst is deposited on the surface of the titanium dioxide catalyst. The organo-iridium catalyst can be attached to the titanium dioxide surface through condensation reaction (with elimination of a water molecule) and/or dative bonding and/or hydrogen bonding. The organo-iridium catalyst can catalyze the production of oxygen while the M/titanium dioxide catalyst can catalyze the production of hydrogen. The hybrid catalyst provides an elegant way to produce hydrogen and oxygen from water in acidic to slightly basic conditions (for example, a pH from 1, 2, 3, 4, 5, 6, or 7 to ≦8) or more preferably from neutral to slightly basic conditions (for example, a pH from 7≦8).

1. Photoactive Titanium Dioxide Material

The photoactive titanium dioxide material can include titanium dioxide or titanium dioxide in combination with metal particles. The titanium dioxide catalyst can include from 0.01% up to 1% of one or more metals particles. Such photocatalysts are described in U.S. Patent Application Publication Nos. 20150101923 to Idriss et al., 20150098893 to Idriss et al., 20150090937 to Idriss et al., all of which are incorporated herein by reference. The titanium dioxide can be particles, particles ground into a powder, or both. The titanium dioxide particles can have two main polymorphs, anatase and rutile. In some embodiments, the titanium dioxide particles can include brookite. In a preferred aspect, the particles include anatase and rutile phases. The TiO₂ support can have a ratio of anatase and rutile phase ranges from 1.5:1 to 10:1, from 3:1 to 8:1, 5:1 to 7:1, 6:1 to 5:1, or from 5:1 to 4:1. The percentage of anatase to rutile the titanium dioxide polymorph can be determined using powder X-ray diffraction (XRD) techniques.

In some embodiments, the anatase to rutile phases in the titanium dioxide particles can be formed by heat treating single phase anatase to transform some of the anatase phase into a rutile phase. For example, titanium dioxide anatase particles can be heated to a temperature of 780° C. to obtain mixed phase titanium dioxide particles. In other embodiments, titanium dioxide rutile phase particles can be mixed with titanium dioxide anatase particles to obtain the desired ratio. The mean particle size of the mixed phase or single phase TiO₂ nanoparticles is less than 100 nm. The TiO₂ nanoparticles have a mean particle size of less than 95 nm, from about 10 nm to about 80 nm, from about 15 nm to about 50 nm, from about 20 nm to about 50 nm, or from about 15 nm to about 20 nm. A BET surface area of the TiO₂ nanoparticles can range from 40 to 60 m²/g or any value or range there between. Titanium dioxide nanoparticles are commercially available as Aeroxide® P25 from Evonik Industries (Germany) or as titanium (IV) oxide powder from Sigma-Aldrich® (USA).

In some embodiments, each of the different phases of titanium dioxide can be purchased from various manufactures and supplies (e.g., titanium (IV) oxide anatase nano powder and titanium (IV) oxide rutile nano powder in a variety of sizes and shapes can be obtained from Sigma-Aldrich® Co. LLC (St. Louis, Mo., USA) and from Alfa Aesar GmbH & Co KG, A Johnson Matthey Company (Germany)), all phases of titanium dioxide from L.E.B. Enterprises, Inc. (Hollywood, Fla. USA)). They can also be synthesized using known sol-gel methods.

With respect to the metal material (e.g., silver (Ag), palladium (Pd), platinum (Pt), gold (Au), nickel (Ni), cobalt (Co), Rhodium (Rh), Ruthenium (Ru), Iridium (Ir), or copper (Cu) nanoparticles, or any combination thereof), it can also be obtained from a variety of commercial sources in a variety of forms (e.g., particles, rods, films, etc.) and sizes (e.g., Nano scale or Micro scale). In preferred instances, gold, silver, and/or palladium can be used). Alternatively, they can be made by any process known by those of ordinary skill in the art. In a non-limiting aspect, the metal particles can be prepared using known co-precipitation, deposition-precipitation or impregnation methods. The metal particles can be used as conductive material for the excited electrons to ultimately, reduce hydrogen ions to produce hydrogen gas. The metal particles can be substantially pure metal particles. The metal particles can also be binary or tertiary alloys. The metal particles are highly conductive materials, making them well suited to act in combination with the photoactive material to facilitate transfer of excited electrons to hydrogen before an electron-hole recombination event occurs or by increasing the time that such an event occurs. The metal particles can also enhance efficiency via resonance plasmonic excitation from visible light, enabling capture of a broader range of light energy. The metal particles can be of any size compatible with the titanium dioxide. In some embodiments, the metal particles are nanostructures. The nanostructures can be of any form suitable for use in the photoactive catalytic systems of the present invention, including but not limited to nanowires, nanoparticles, nanoclusters, nanocrystals, or combinations thereof.

The photoactive titanium dioxide catalysts can be prepared using known methods (see, e.g., U.S. Nos. 20150101923, 20150098893, and 20150090937). A non-limiting example of preparation of the metal doped-titanium dioxide catalyst includes contacting an aqueous solution of titanium dioxide ions in the presence of metals particles from Columns 8-11 of the Periodic Table followed by precipitation or impregnation, where the metal particles are attached to at least a portion of the surface of precipitated titanium dioxide crystals or particles. Non-limiting examples of these metals include gold (Au), silver (Ag), pallidum (Pd), platinum, nickel (Ni), cobalt (Co), rhodium (Rh), iridium (Ir), copper (Cu) and ruthenium (Ru). Metal particles can be obtained in their metal salt precursor forms from commercial sources. A non-limiting example of a commercial source for metal particle precursors is Sigma Aldrich® (U.S.A.). Alternatively, the metal particles can be deposed on the surface of the titanium dioxide particles by any process known by those of ordinary skill in the art. Deposition can include attachment, dispersion, and/or distribution of the metal particles on the surface of the titanium dioxide. As another non-limiting example, the TiO₂ particles can be mixed in a volatile solvent with the metal particles. After stirring and sonication, the solvent can be evaporated off. The dry material can then be ground into a fine powder and calcined (such as at 300° C.) to produce the titanium dioxide catalysts of the present invention. Calcination (such as at 300° C.) can be used to further crystalize the titanium dioxide particles. In non-limiting embodiments, the total amount of metal deposited on the surface of the titanium dioxide can be 0.0500 wt. %, 0.0525 wt. %, 0.0550 wt. %, 0.0575 wt. %, 0.0600 wt. %, 0.0625 wt. %, 0.0650 wt. %, 0.0675 wt. %, 0.0700 wt. %, 0.0725 wt. %, 0.0750 wt. %, 0.0775 wt. %, 0.0800 wt. %, 0.0825 wt. %, 0.0850 wt. %, 0.0875 wt. %, 0.0900 wt. %, 0.0925 wt. %, 0.0950 wt. %, 0.0975 wt. %, 0.1000 wt. %, 0.1250 wt. %, 0.1500 wt. %, 0.1750 wt. %, 0.2000 wt. %, 0.2250 wt. %, 0.2500 wt. %, 0.2750 wt. %, 0.3000 wt. %, 0.3250 wt. %, 0.3500 wt. %, 0.3750 wt. %, 0.4000 wt. %, 0.4250 wt. %, 0.4500 wt. %, 0.4750 wt. %, 0.5000 wt. %, 0.5250 wt. %, 0.0550 wt. %, 0.5750 wt. %, 0.6000 wt. %, 0.6250 wt. %, 0.6500 wt. %, 0.6750 wt. %, 0.7000 wt. %, 0.7250 wt. %, 0.7500 wt. %, 0.7750 wt. %, 0.8000 wt. %, 0.8250 wt. %, 0.8500 wt. %, 0.8750 wt. %, 0.9000 wt. %, 0.9250 wt. %, 0.9500 wt. %, 0.9750%, up to 1.0%, or any range derivable therein, based on the total weight of the metal-doped titanium dioxide catalyst. In other embodiments, the metal doped titanium dioxide catalyst can include 0.4 wt. % of Ag and 0.1 wt. % of Pd, 0.1 wt. % of Ag and 0.4 wt. % of Pd, 0.6 wt. % of Ag and 0.4 wt. % of Pd, or 0.4 wt. % of Au and 0.65 wt. % Pd.

2. Organo-Iridium Catalyst

The organo-iridium catalyst can be a Kläui type compound. Such a compound can have a general formula of {(R₁,R₂,R₃,R₄,R₅—O₅)M[RR′PO]₃}⁻ and the general structure (I) shown below.

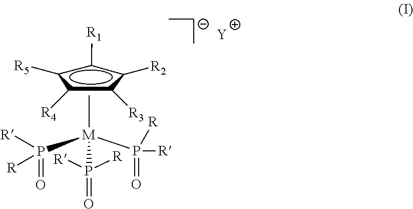

where M is a transition metal, M is preferably Ir, Rh and Co; R¹ to R⁵ are the same or different and are H, C₁ to C₄ alkyl moieties, or a combination thereof, preferably R¹ to R⁵ are methyl moieties; R and R′ are the same or different and are C₁ to C₄ alkyl moieties or OC₁ to OC₄ alkoxyl moieties, or a combination thereof, preferably R to R′ are methyoxyl moieties; Y⁺ is a charge balancing cation, preferably Nat

In the present invention, compound (I), M is iridium and the aromatic cyclpentyldienyl group (Cp*) can include substituents such as alkyl groups. The iridium containing catalyst can have the general structure (II) shown below.

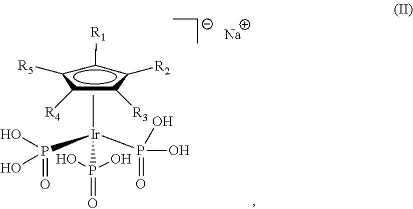

where R¹ to R⁵ are the same or different and are H, C₁ to C₄ alkyl moieties, or a combination thereof, preferably R¹ to R⁵ are methyl moieties. In a particular embodiment, the Cp* group is 1,2,3,4,5 methylcyclopentadienyl (C₅Me₅) as shown below

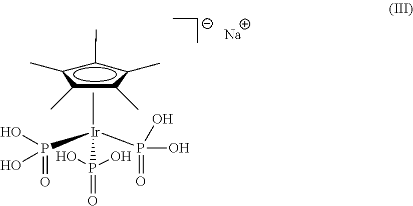

The organo-iridium catalyst (II) or (III) can be made as described using known organometallic synthesis methods or by the procedure exemplified in the Examples section. In a non-limiting example, compound (II) or (III) can be obtained through acid hydrolysis of the corresponding organo-iridium methyl ester (IV) shown below as shown in the equation (4) below. The methyl ester can be made using known organometallic methods as described in Scotti et al., in Inorganica Chemica Acta, May 1993, titled “[Cp*Ir{P(O)(OMe)₂}₃]”, an iridium(III) phosphonate complex acting as a chelating oxygen ligand: synthesis and coordination chemistry”, which is incorporated herein by reference.

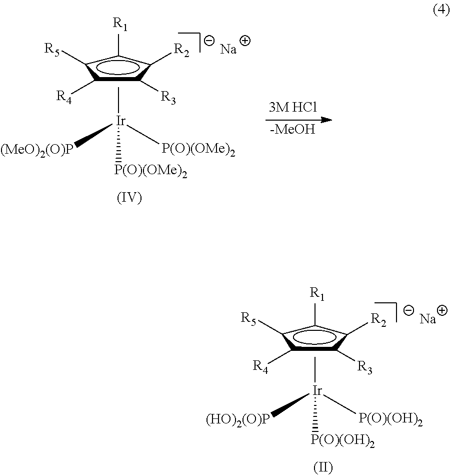

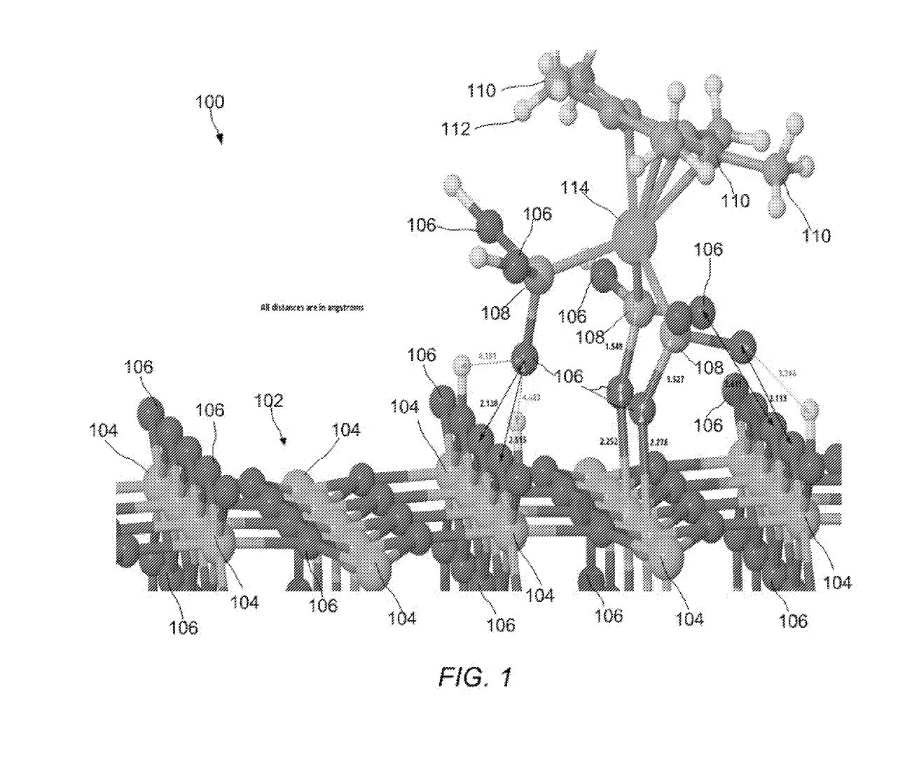

The iridium containing catalyst (compound (II) or (III)) can covalently bond to solid surfaces through the at least one oxygen atom attached to a phosphorous atom (See, FIG. 1). In some embodiments, the orientation of the three doubly bonded oxygen atoms can be tripodal. Without wishing to be bound by theory, it is believed that these oxygen atoms have the ability to bind to the metals or metalloids via covalent, dative and hydrogen bonding interactions. The iridium containing catalyst of the present invention and its base conjugates are soluble in aqueous medium. Thus, the iridium containing catalyst compound can be used in homogeneous catalysis of water oxidation.

The organo-iridium catalyst (II) or (III) has three polyprotic ligands ([PO(OH)₂]⁻) with each ligand having two acidic hydrogens. The polyprotic ligands can be deprotonated in basic solution by a buffer or when treated with strong base, for example, sodium hydroxide, potassium hydroxide or the like. The equivalents of base needed for the deprotonation reaction can be determined through acid-base titrimetric methods as exemplified in the Example section or other known acid-base titration methods. A non-limiting example of the determination of base equivalents can include dissolving a known amount of compound (II) (e.g., compound (III)) and titrating the solution with basic solution of known concentration (e.g., a 0.01 M NaOH solution). The pH values can be plotted versus the volume of base a plot of pH versus volume of 0.01 M NaOH added in mL. From analysis of the titration data, the equivalence points can be determined by the changes in the slope of the plot. Since the organo-iridium catalyst has several acidic hydrogens (H⁺ counter ion, OH groups present on the phosphonic acid moieties) and, as in the case of many polyprotic acids, it may not be possible to detect any single equivalent point. Each ([PO(OH)₂]⁻) ligand has two acidic hydrogen, therefore, 2 moles of base are needed per mole ([PO(OH)₂]⁻) ligand. Compound (II) has three ([PO(OH)₂]⁻) ligands so the base equivalents can range from 1, 2, 3, 4, 5, and 6 with 6 equivalents being the amount of base need for complete neutralization.

3. Hybrid Catalysts

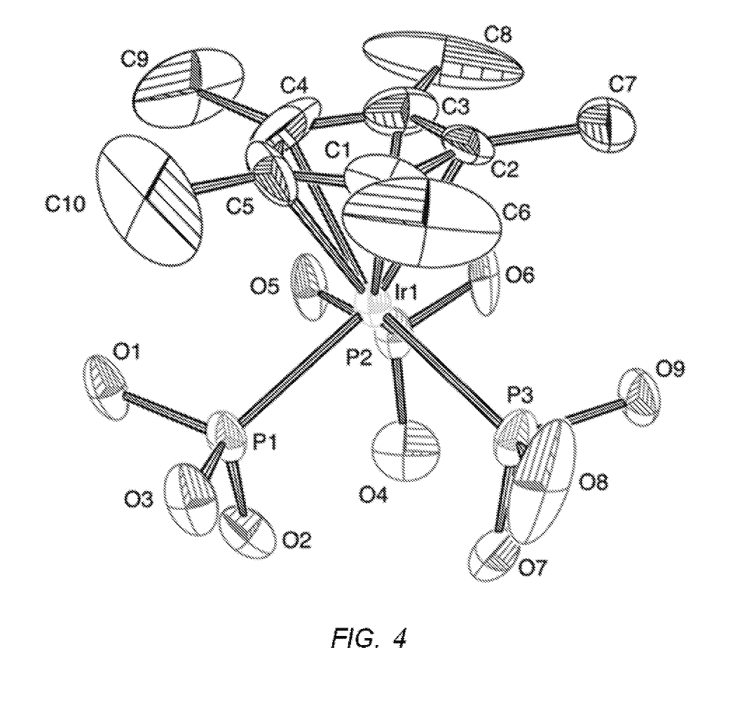

The hybrid catalyst of the present invention is the organo-iridium catalyst of the present invention (for example, compound (II) or compound (III)) deposited on the surface of a photoactive material (for example, titanium dioxide or metal-doped titanium dioxide). FIG. 1 is an illustration of the hybrid catalyst 100. In FIG. 1, the surface 102 here includes the (110) rutile surface having Ti cations 104, O anions 106, P anions 108, C atoms 110, H atoms 112 and the Ir atom 114. The Ir complex in this representation has the structure obtained experimentally (See, Example 2, and FIG. 4). The TiO₂ surface is that obtained by Density Functional Theory at the GGA with PBE functional and its structural parameters matches those obtained experimentally. The hybrid catalyst 100 of the present invention can be made by mixing the photoactive titanium dioxide material in an aqueous solution of the iridium-containing compound at room temperature under agitation. The resulting particulate matter can be isolated using known filtration techniques and washed with a series of solvents to remove. The solvents can include acidic water, acetonitrile and methylene chloride. The resulting hybrid catalyst can be dried under vacuum to remove any residual water or solvent, for example, at a temperature of about 100° C. to 120° C. A total content of iridium deposited on the surface of the photoactive titanium dioxide material can range from about 1×10⁻⁶ mol/g to 1×10⁻⁵ mol/g, about 2×10⁻⁶ mol/g, 3×10⁻⁶ mol/g, 5×10⁻⁶ mol/g, 7×10⁻⁶ mol/g, 8×10⁻⁶ mol/g, 9×10⁻⁶ mol/g, or any range there between. In a particular embodiment, the total content of iridium deposited on the surface of the photoactive titanium dioxide material is about 8.5×10⁻⁶ mol/g. Without wishing to bound by theory it is believed that the oxygen atoms of the iridium containing catalyst attaches or directly contacts the titanium or other metals (e.g., gold, silver, palladium) on the surface of the titanium dioxide. In some instances the organo-iridium compound can datively bond to the titanium, gold, silver or palladium atoms.

The hybrid catalyst is stable in media having a pH ranging from 0 to 14. It was surprisingly discovered that the organo-iridium compound did not leach or detach from the surface of the titanium dioxide surface when the hybrid catalyst was subject to aqueous basic and acidic solutions for 20 to 24 hours at room temperature.

B. Production of Hydrogen and Oxygen from Water

1. Hybrid Catalyzed Production of Hydrogen and Oxygen

The hybrid catalyst can catalyze the oxidation of water to generate hydrogen and oxygen under photocatalytic conditions. A method to produce oxygen and hydrogen from water can include irradiating a composition that includes the hybrid catalyst in combination with an aqueous solution neutral/slightly basic by a buffer or that include at least 4 equivalents of base with respect to the iridium-containing catalyst. In some embodiments, a sacrificial oxidant such as cerium ammonium nitrate (CAN) or sodium periodate (NaIO₄) or a photosensitizer/electron acceptor system such as ruthenium(II)-tris-2,2′-bipyridine/sodium persulfate ([Ru(bipy)]²⁺/Na₂S₂O₈) is present in the composition. The sacrificial oxidant can help lower the oxidation half reaction. In a preferred embodiment, sodium periodate (NaIO₄) is present in the composition. In a particular embodiment, the composition is absent of CAN. In some embodiments, the hybrid catalyst can be partially soluble in the composition, thus allowing heterogeneous and homogenous catalysis to occur.

It was surprisingly found that the activity of the catalyst increased when neutral/slightly basic conditions by a buffer or at least 4 equivalents, 5, 6, 7, 8, 9, 10, 11, 12, 13, 14, 15, 16, 17, 18, 19, 20, 21, 22, 23, 24, 25, 26, 27, 28, 29, 30, 31, 32 or more equivalents of base were used. The pH of the aqueous composition can range from 1 to 14, with a pH of 7 to ≦8 being preferred. In the presence of at least 4 equivalents of base, the hybrid catalyst has a TON of at least 200, 500, 1000, 1500, 2000, 5000, 1000 to 5000, 1500 to 3000 or any range there between. In a particular embodiment, the TON can be at least 1500 when at least 8 equivalents of base are used at a sacrificial oxidant to catalyst to ratio 3800 to 6900. When a sacrificial oxidant is used, a ratio of sacrificial oxidant to catalyst can range from 400 to 7000, with a ratio of about 775 being preferred. At pH=7.7 the hybrid catalyst has a TOF ranging from 40 to 90 min⁻¹.

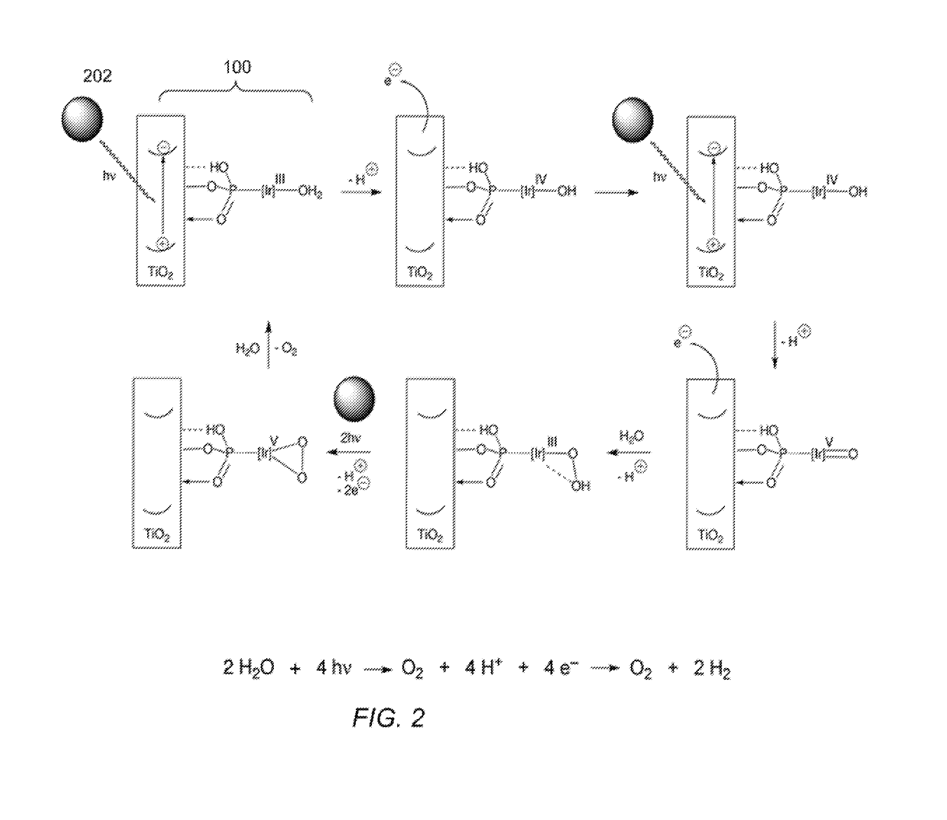

Without wishing to be bound by theory, the multiple mechanisms of the production of water and hydrogen from water is illustrated in FIG. 2. FIG. 2 is an illustration of a mechanism of action for the hybrid catalyst of the present invention. In FIG. 2, [Ir] is [Cp*Ir{P(O)(OH)₂}]⁻. Light source 202 contacts photocatalyst 100, thereby exciting electrons (e−) from their valence band to their conductive band, thereby leaving corresponding holes (h+). The holes migrate to the surface of the TiO₂ and oxidize the iridium complex that catalyzes water oxidation to O₂ thus generating H⁺, while electrons in the conduction band of TiO₂ are transferred to metal nanoparticles which act as cathodic sites for for H₂ evolution (2H⁺+2e⁻→H₂).

2. Organo-Iridium Catalyzed Production of Hydrogen and Oxygen

The iridium-containing catalyst can catalyze the oxidation of water to generate hydrogen and oxygen. A method to produce oxygen from water can include the iridium-containing catalyst in combination with an aqueous solution. In some embodiments, a sacrificial oxidant such as cerium ammonium nitrate (CAN) or sodium periodate (NaIO₄), or sodium persulfate/ruthenium(II)-tris-2,2′-bipyridine (Na₂S₂O₈/[Ru(bipy)]²⁺) is present in the composition. In a preferred embodiment, sodium periodate (NaIO₄) is present in the composition. In a particular embodiment, the composition is absent of CAN. In some embodiments, the iridium-containing catalyst and composition form a homogeneous solution.

It was surprisingly found that the activity of the catalyst increased when neutral/slightly basic conditions by a buffer or at least 4 equivalents, 5, 6, 7, 8, 9, 10, 11, 12, 13, 14, 15, 16, 17, 18, 19, 20, 21, 22, 23, 24, 25, 26, 27, 28, 29, 30, 31, 32 or more equivalents of base were used. The pH of the aqueous composition can be range from 1 to 14, with a pH of 7 to ≦8 being preferred. In the presence of at least 4 equivalents of base, the organo-iridium catalyst has a TON of 950 to 1100, 960 to 1090, 970 to 1080, 980 to 1070, 990 to 1060, 1000 to 1050 or any range there between. When a sacrificial oxidant is used, a ratio of sacrificial oxidant to catalyst can range from 2000 to 2200, with a ratio of about 2180 being preferred. At pH=7.7 the hybrid catalyst has a TOF ranging from 36 to 153 min⁻¹.

C. Water Oxidation System with Hybrid Catalyst

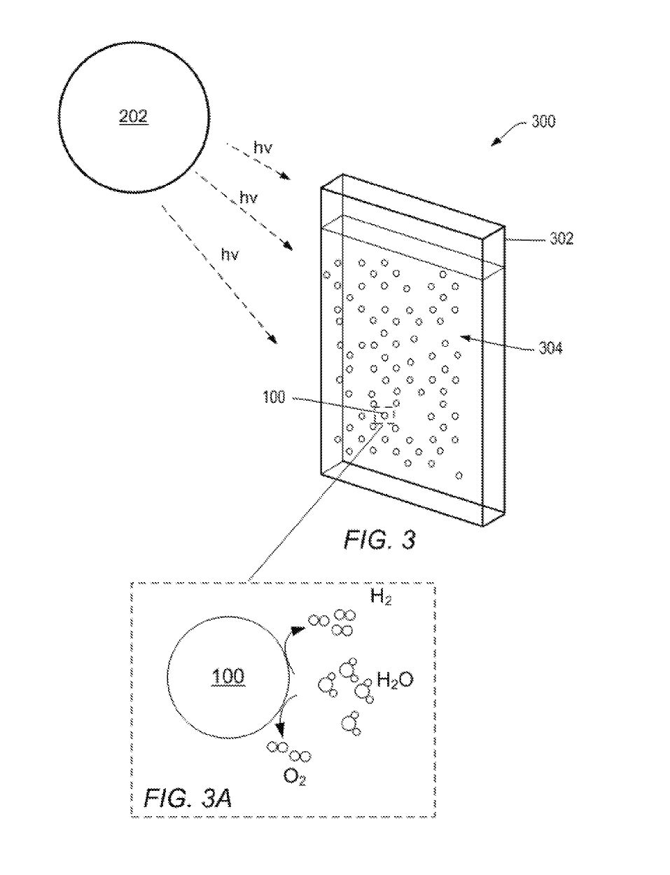

FIG. 3 is a schematic of an embodiment of water oxidation system 300. Water-splitting system 300 includes container 302, light source 202, catalyst/photocatalyst 100, and aqueous solution 304 having neutral or slightly basic pH (e.g. a pH of 7 to 9) maintained with a buffer or maintained with a base that is present in the in the aqueous solution at least 4 times equivalent with respect to the organo-iridium catalyst present on the hybrid catalyst. Container 302 can be translucent or even opaque such as those that can magnify light (e.g., opaque container having a pinhole(s)). Catalyst/photocatalyst 100 can include the iridium-containing catalyst, the hybrid catalyst or both. As shown in FIG. 1, the catalyst/photocatalyst 100 is the iridium-containing catalyst deposited on the surface of the titanium dioxide single nanoparticles dispersed in the media. In some embodiments, the photocatalyst is the organo-iridium catalyst and is dissolved in the aqueous solution 304. Light source 202 is sunlight, a UV lamp, or a Xe lamp providing both UV and visible light. An example of a UV light is a 100 Watt ultraviolet lamp with a flux of about 2 mW/cm² at a distance of 10 cm. The UV lamp can be used with a 360 nm and above filter. Such UV lamps are commercial available from, for example, Sylvania. Photocatalyst 100 can be used to split water to produce O₂ and H₂. Photocatalyst 100 can be used to split water to produce H₂ and O₂ as shown in FIG. 3B, which is an exploded view of the region near a photocatalyst 100 in water-splitting system 300. Light source 202 can contact the aqueous composition which includes the hybrid catalyst and a buffer or an aqueous base having at least 4 equivalents of base with respect to the iridium-containing compound. Notably, system 300 does not require the use of an external bias or voltage source. Further, the efficiency of system 300 allows for one to avoid or use minimal amounts of a sacrificial agent. In some embodiments, the photocatalyst is supported on (e.g., adhered or coupled to) a substrate such as glass, polymer beads, or a metal oxide.

In addition to being capable of catalyzing water splitting without an external bias or voltage, the catalyst/photocatalysts of the present invention may be included in an anode of an electrochemical cell capable of forming oxygen and hydrogen by electrolysis of water. In a non-limiting example, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light or light flux.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### Synthesis of Iridium (III) Containing Compounds

1. [(C₅Me₅)Ir{P(O)(OMe)₂}₃]⁻Na⁺ (Complex 1, See Compound (IV) in Scheme (4)).

Complex 1 was synthesized according to the procedure of Scotti et al., in Inorganica Chemica Acta, May 1993, titled “[Cp*Ir{P(O)(OMe)₂}₃]⁻, an iridium(III) phosphonate complex acting as a chelating oxygen ligand: synthesis and coordination chemistry”, which is incorporated herein by reference. In particular, [Cp*IrCl₂]₂ (2.4252 g, 3.04 mmol and AgClO₄ (2.7402 g, 13.22 mmol) were dissolved in acetone (150 mL) and left under magnetic stirring for 10 min at room temperature in the absence of light. The AgCl precipitated and was removed by filtration. Trimethylphosphite ((P(OMe)₃), 3.40 g, 27.40 mmol) was added at the resulting solution. After 30 min, diethyl ether was added to precipitate a white solid [Cp*Ir{P(OMe)}₃](ClO₄)₂, which was washed with diethyl ether and dried in vacuum overnight. The product was recrystallized from acetone by slow addition of diethyl ether. The white solid obtained was dried in vacuum overnight. The yield was 4.4850 g (yield 82%).

To a solution of [Cp*Ir{P(OMe)}₃](ClO₄)₂ (4.4850 g, 5.0 mmol) in acetone (40 mL), NaI (7.5878 g, 49.6 mmol) was added. The mixture was stirred at room temperature for 45 h. The solvent was removed under reduced pressure and the light yellow solid residue was washed with n-hexane (twice, with 50 mL each time) to eliminate 4-hydroxy-4-methylpentan-2-one, which formed in an appreciable amount by aldol condensation of acetone. Finally, the product was dissolved in dichloromethane (250 mL); the solution was filtered and evaporated to dryness. The residual solid was re-crystallized from dichloromethane/n-hexane to obtain (3.2236 g, yield 95%) g of compound IV as a light yellow solid. The resulting iridium containing Complex 1 was characterized by ¹H and ³¹P NMR spectroscopy.

2. [(C₅Me₅)Ir{P(O)(OH)₂}₃]⁻Na+(Complex 2, See Compound (III) in Scheme (4)).

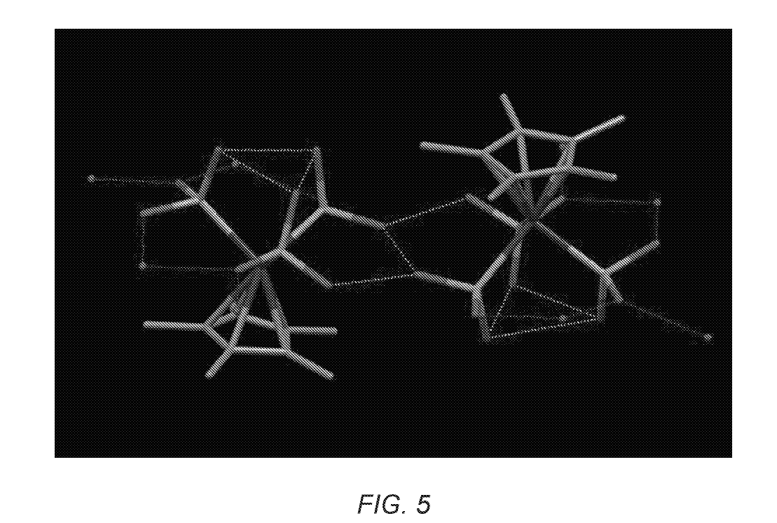

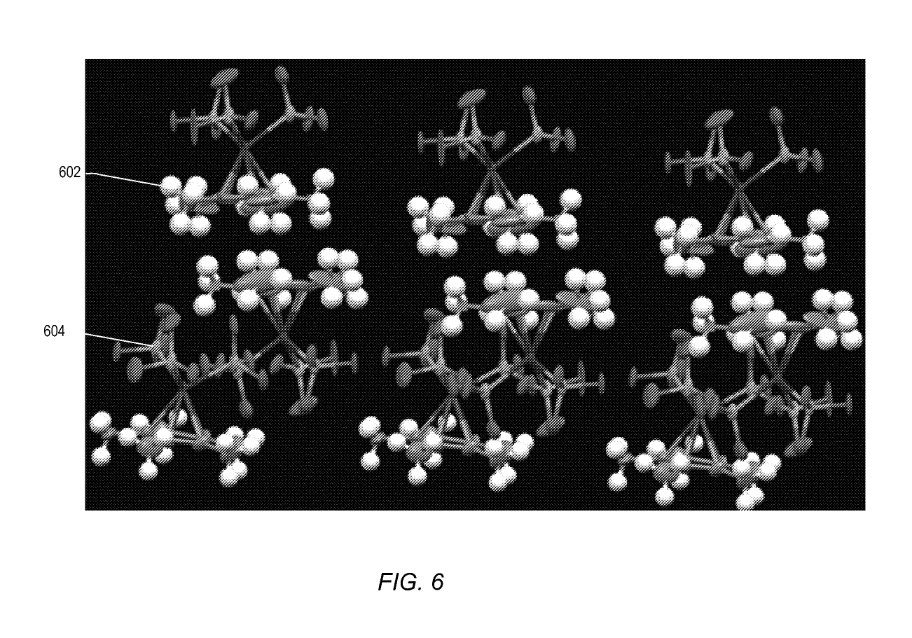

A solution of iridium containing Complex 1 (3.2236 g, 4.7·10⁻³ mol) was mixed with aqueous hydrochloric acid (100 mL, 3M) for about 20 hours. The resulting yellow solution was evaporated at reduced pressure and at 80° C. A clear yellow residue was obtained that was left for 3 hours under vacuum. The solid was then treated with 50 mL of acetone: a yellow solution and a white solid residue were obtained. The white solid was removed by filtration and washed with 5 mL of acetone. The solution was evaporated under reduced pressure at 60° C. to produce Complex 2 as a yellow-brownish solid (2.6574 g, yield 99%). Complex 2 was characterized by ¹H and ³¹P NMR spectroscopy. The solid-state structure of Complex 2 was determined by X-ray diffraction on crystals obtained by very slow evaporation of a dimethylformamide solution of Complex 2. FIG. 4 is an Oak Ridge Thermal Ellipsoid Plot (ORTEP) view of Complex 2. FIG. 5 is an illustration of the intermolecular hydrogen bonding network in the organo-iridium catalyst of the present invention. FIG. 6 is a crystal structure of Complex 2 showing the alternating layers of methyl cyclopentadienyl (Cp*) and phosphonic acid moieties. From the crystal structures it was determined that the solid state structure of Complex 2 consists of regular and alternating layers of hydrophobic Cp* moieties (602) and hydrophilic phosphonic groups (604) as represented in FIG. 6. From the X-ray diffraction analysis it was determined that counter ion was Na⁺.

### Example 2

### Base Equivalents of Complex 2

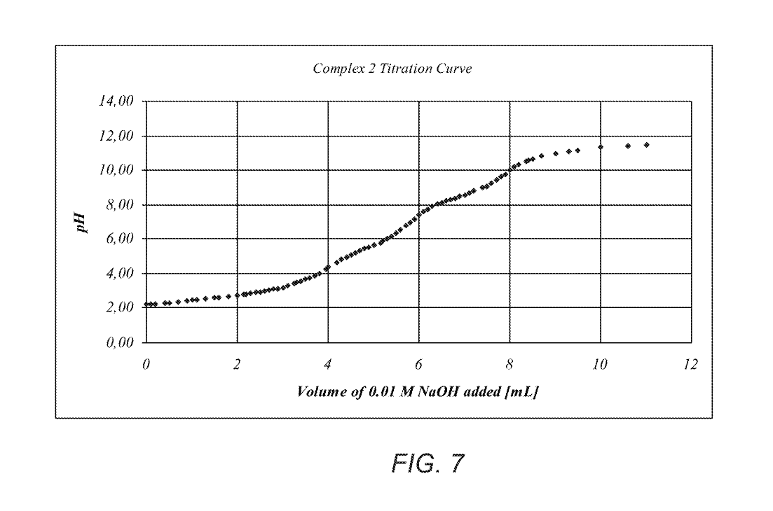

The acid equivalents of the Complex 2 were determined by sodium hydroxide titration. A sample of complex 2 (0.01326 g, 2.32×10⁻⁵ mol) was dissolved in water (2.0 mL) and titrated with a 0.01 M NaOH solution. FIG. 7 is a plot of pH versus volume of 0.01 M NaOH added in mL. The equivalent points were determined by the use of bench pH-meter. From analysis of the titration data, it was determined that Complex 2 had at least three different equivalent points after the addition of 4, 6 and 8 mL of NaOH 0.01 M. A slight change in the slope of the titration plot was seen in correspondence to the addition of ca. 2 mL of NaOH 0.01 M, which suggested the possibility of a fourth equivalent point. Complex 2 has several acidic hydrogens (H⁺ counter ion, OH groups present on the phosphonic acid moieties) and, as in the case of many polyprotic acids, the detection of a single equivalent point was difficult. Since the amount of Complex 2 in the solution was about 2×10⁻⁵ mol and that each mL of NaOH 0.01 M contained 1×10⁻⁵ mol base, the equivalent points (change in slope) were determined to correspond to about 2, about 3 and about 4 equivalents of NaOH. Thus, an estimate of the pKa of the species involved in the neutralization process from the titration plot was determined to have pKa values of pKa1≈3; pKa2≈6; pKa3≈9.

### Example 3

### Synthesis of Hybrid Catalyst

1. [(C₅Me₅)Ir{P(O)(OH)₂}₃]⁻Na+Deposited on TiO₂.

Solid rutile TiO₂ (0.99956 g, Rutile TiO₂, <100 nm powder, Sigma-Aldrich®) was added to aqueous solution of Complex 2 (3-4×10⁻³ M) at room temperature and left under stirring overnight. The resulting suspension was centrifuged (4000 rpm, 30-40 min) and the supernatant solution was removed to isolate the hybrid catalyst. The solid was washed (and each time the supernatant was removed after centrifugation) twice with 5 mL of deionized water, 5 mL of 0.1 M HNO₃, 5 mL of CH₃CN and 5 mL of dichloromethane. The solid was finally dried under vacuum at room temperature overnight. Catalyst loading in 2 TiO2 was determined by inductively coupled plasma atomic emission spectroscopy (ICP-OES) analysis, after having dissolved the sample (0.05100 g) in an aqueous solution (25.0 mL) of H₂SO₄ (96%)/(NH₄)₂SO₄ (0.3206 g) by refluxing it at about 350° C. A total content of 1.64×10⁻³ g of Ir/g of TiO₂ was determined. Thus, the catalyst loading was 8.54×10⁻⁶ mol/g. Complex 2 anatase TiO₂ catalyst was also made using this procedure.

2. Complex 2 Metal-Doped Titanium Dioxide.

Complex 2 was deposited on silver/palladium-doped titanium dioxide or gold/palladium catalysts having the metal weight percentages listed in Table 4 using the procedure of Examples 3.1.

### Example 4

### Oxidation of Water Using Complex 1 and Complex 2

Complex 1 and Complex 2 were tested as water oxidation catalysts in the presence of cerium ammonium nitrate (CAN) as a sacrificial oxidant (for the electron reduction side of the reaction). Several catalytic runs were recorded, by changing catalyst and oxidant concentrations, and their performance for oxygen production from water were monitored. Water oxidation experiments were performed at pH 1 (by HNO₃). Gas production was monitored through differential manometric measurements performed with a Testo 521-1 manometer. In a typical experiment 4.9 mL of a solution of 2 in 0.1 M HNO₃ with the proper concentration and 4.9 mL of 0.1 M HNO₃ solution were transferred in a homemade glass tube (working cell) and into another identical glass tube (reference cell), respectively; both cells, equipped with a side arm for the connection to the manometer and having a septum for the injection of solutions, were maintained under stirring. Both tubes were closed with a septum and connected to the manometer. The system was kept at a constant temperature of 25° C. and allowed to equilibrate for 15-30 min, monitoring the differential pressure. When a steady baseline was achieved, 100 μL of a solution of CAN (with the suitable concentration, pH 1 by HNO₃) and of 0.1 M HNO₃ were injected into the working and reference cells, respectively. Gas evolution was monitored by measuring the differential pressure between the two cells. Table 1 lists the complex used, the concentration of the complex, the molar ratio of CAN to catalyst, turn over frequency, turnover number and oxygen produced.

TABLE 1

| | | Cat | CAN | CAN/Cat | TOF | TON | Oxygen | |
|---|---|---|---|---|---|---|---|---|
| Exp. | Cat | [10⁻⁶ M] | [10⁻³ M] | [molar ratio] | [min⁻¹] | [cycles] | [10⁻⁶ mol] | |
| 1 | 1 | 516 | 5.0 | 9.7 | 0.004 | 0.76 | 1.96 | (31%) |
| 2 | 2 | 5.0 | 5.0 | 1 000 | 30.9 | 238 | 5.95 | (95%) |
| 3 | 2 | 2.5 | 5.0 | 2 000 | 26.1 | 494 | 6.18 | (99%) |
| 4 | 2 | 5.0 | 10.0 | 2 000 | 29.9 | 496 | 12.41 | (99%) |
| 5 | 2 | 2.5 | 10.0 | 4 000 | 22.4 | 971 | 12.14 | (100%) |
| 6 | 2 | 2.5 | 50.0 | 20 000 | 32.4 | 4108 | 51.36 | (82%) |
| 7 | 2 | 1.0 | 50.0 | 50 000 | 68.2 | 8795 | 43.98 | (70%) |

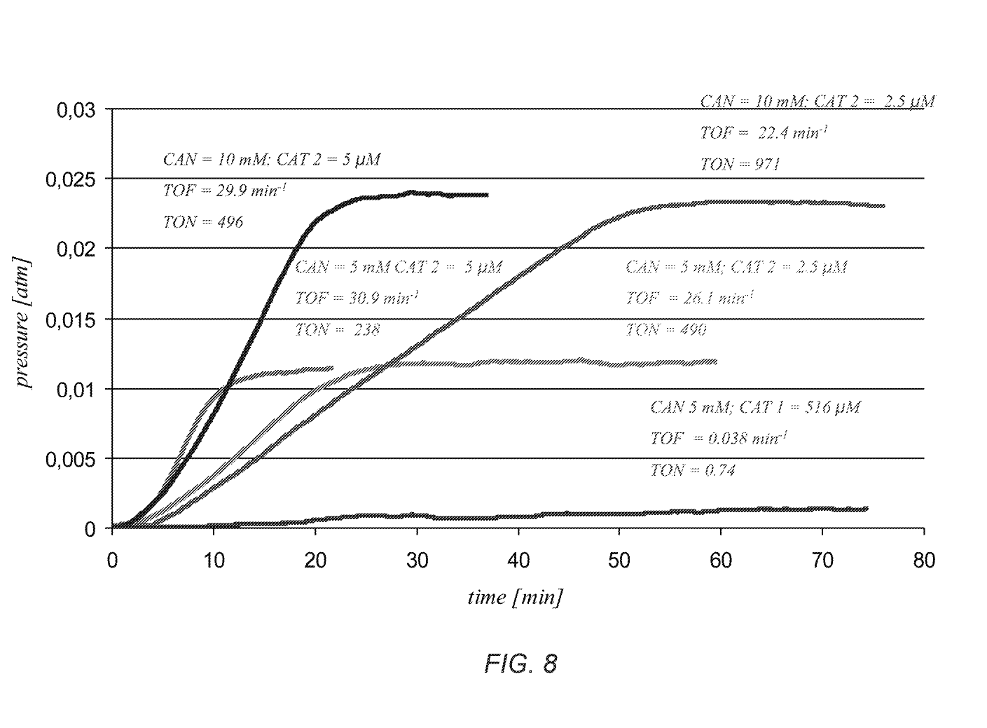

FIG. 8 shows plots of pressure in atmosphere of oxygen versus time in minutes for use of Complexes 1 and 2 as catalysts 1 and 2 respectively in the water oxidation reactions listed in Table 1. From analysis of the data in Table 1 and FIG. 8, Complex 1 was nearly inactive (experiment 1) whereas the amount of evolved oxygen is quantitative for Complex 2 with a concentration of CAN up to 10⁻²M, (Experiments 2-5) and consistent with the water oxidation stoichiometry shown in the equation below:

4Ce⁺⁴+2H₂O=4Ce⁺³+4H⁺+O₂

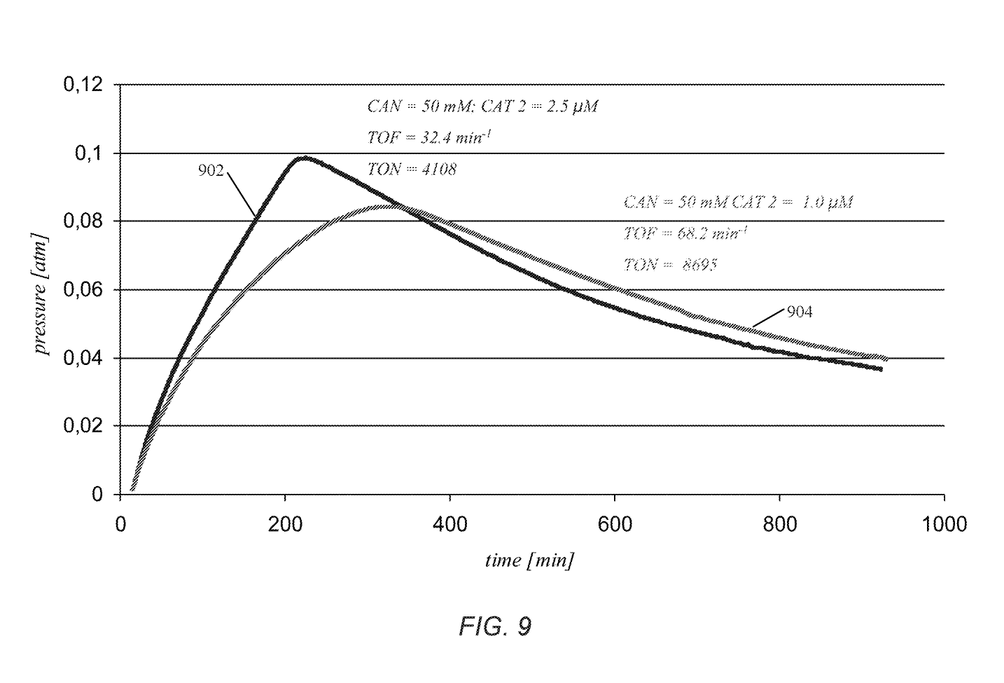

In Experiments 2-6, Complex 2 (Catalyst 2) proved to be able to oxidize water with a TOF of ca. 30 min⁻¹, reaching a TON ranging from 240 to 970. In Experiment 6, a TON of 4100 with CAN 50 mM, catalyst 2.5 μM (82.1% of theoretical oxygen production) was obtained. In Experiment 7, with a 5×10⁴ CAN/catalyst molar ratio (50 mM CAN; 1.0 μM catalyst), oxygen production was 44×10⁻⁶ mol O₂ (70.2% of the theoretical amount), which gave a TON of about 8800. FIG. 9 shows plots of pressure in atmosphere of oxygen versus time in minutes. Data 902 is Experiment 6 and data line 904 is Experiment 7. As shown in Experiment 7, Complex 2 was resistant to an increase in the oxidant concentrations of, at least, 12.5 fold.

### Example 5

### Oxidation of Water Using Hybrid Catalyst with CAN

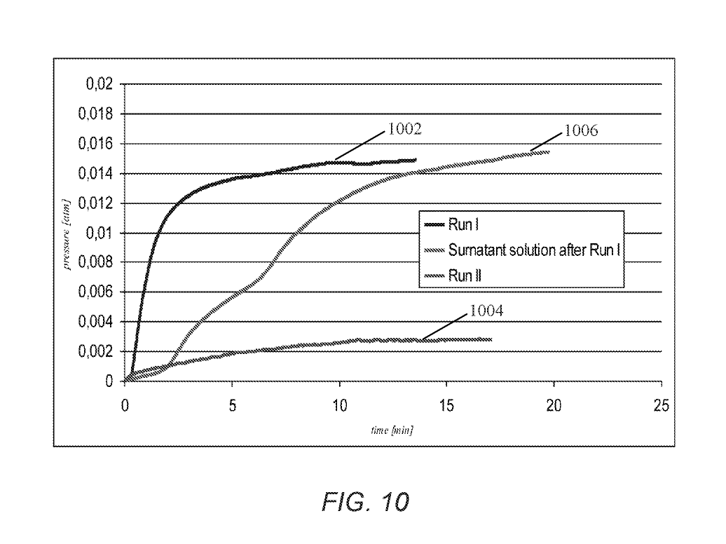

Water oxidation experiments were performed at pH 1 (by HNO₃). Gas production was monitored through differential manometric measurements performed with a Testo 521-1 manometer. In a typical experiment, the appropriate mass of hybrid catalyst was weighed directly into the working cell, whereas the reference cell was left empty. 4.950 mL of a CAN solution (proper concentration in order to obtain the desired final concentration, pH 1 by HNO₃) and a 0.1 M HNO₃ solution were transferred in a homemade glass tube (working cell) and into another identical glass tube (reference cell), respectively. Both tubes were closed with a septum and connected to the manometer. The system was kept at a constant temperature of 25° C., under stirring, and allowed to equilibrate with stirring for 15-30 min, monitoring the differential pressure. When a steady baseline was achieved, a 0.1 M HNO₃ solution (e.g. 50 μL) and a CAN solution (e.g. 50 μL of a 100 mM solution of sacrificial oxidant to obtain a final concentration of 10 mM) were added into the reference and working cells, respectively. Gas evolution was monitored by measuring the differential pressure between the two cells. FIG. 10 shows plots of oxygen pressure in atm versus time in minutes for the Complex 2 TiO₂ catalysis of water oxidation in the presence of CAN. Data line 1002 is an initial water oxidation experiment (blue line). Data line 1004 is a second water oxidation experiment using the supernatant obtained by centrifugation and filtration of the initial experiment. Data line 1006 is a third water oxidation experiment using the solid obtained from the centrifugation of the initial experiment. From analysis of the data, the initial experiment (data line 1002) showed an oxygen pressure versus time plot similar to those observed in homogenous catalysis. The supernatant experiment was active toward water oxidation when CAN was added (data line 1006), thus indicating leaching of Complex 2 into the solution. Finally, the residual solid showed very little catalytic activity (data line 1004). Without wishing to be bound by theory, it is believed that the leaching of Complex 2 was due to the high affinity of Complex 2 and cerium.

### Example 6

### Oxidation of Water Using Hybrid Catalyst and NaIO₄

1. Complex 2 TiO₂ Hybrid Catalyst.

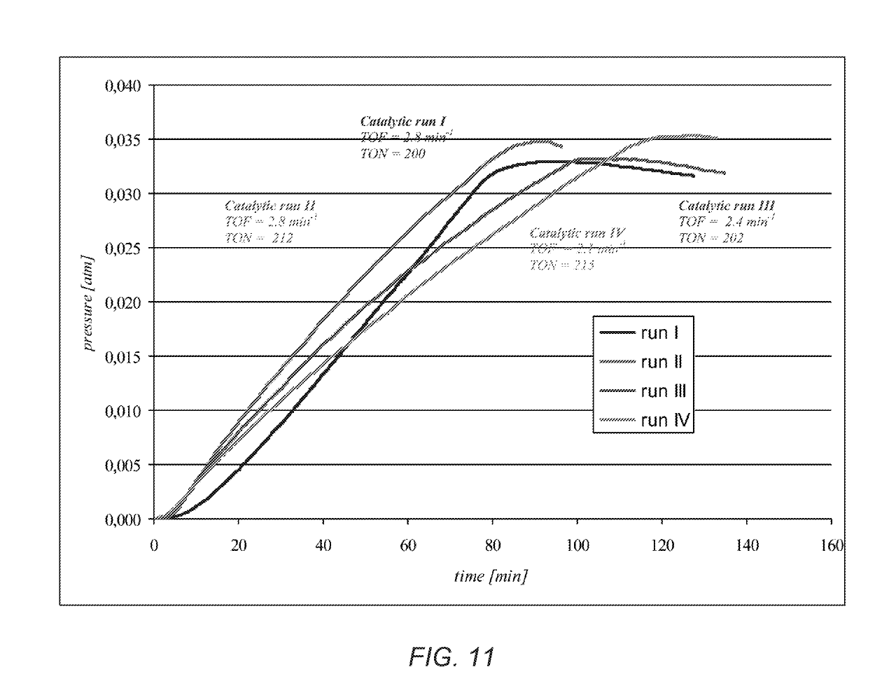

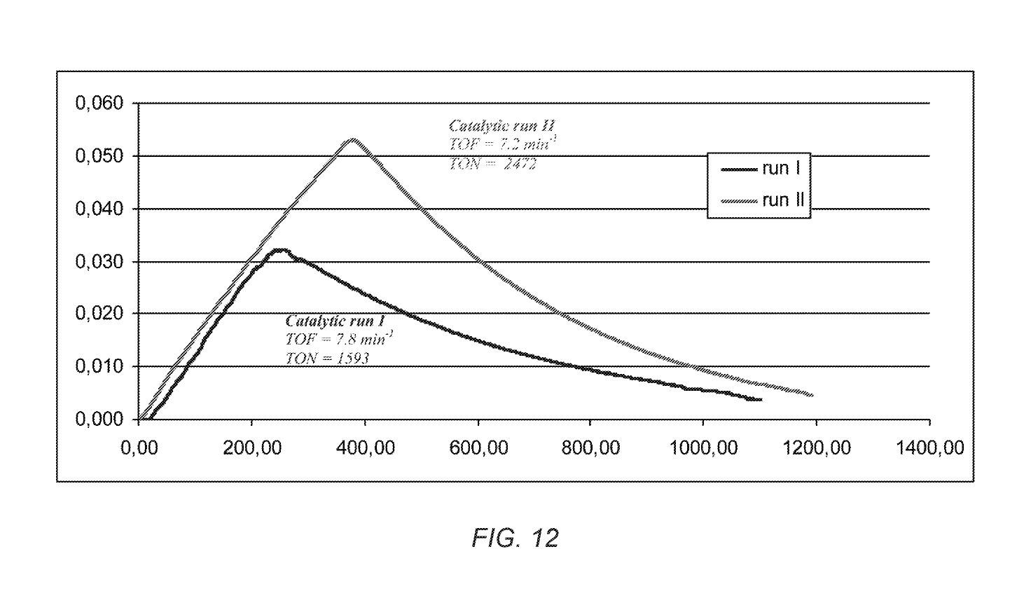

Complex 2 deposited on rutile or anatase TiO₂ was tested using NaIO₄ as a sacrificial oxidant using the procedure of Example 5, and deionized water instead of 0.1 M HNO₃ solution. The initial pH was ca. 4.5. Table 2 reports the concentration of the Complex 2 TiO₂ catalyst, the molar ratio of NaIO₄ to catalyst, turn over frequency, turn over number and amount of oxygen produced. FIGS. 11-13 are plots of oxygen pressure in atmosphere versus time in minutes for the Experiments in Table 2. From data analysis, it was concluded that Complex 2 TiO₂ hybrid catalyzed the oxidation of water in the presence of NaIO₄ Complex 2 rutile TiO₂ hybrid catalyst had a higher turnover frequency (TOF=3.0 min⁻¹) than the Complex 2 anatase TiO₂ hybrid catalyst (TOF=1.8 min⁻¹). From the data, the activity of Complex 2 TiO₂ was found to be almost constant at least for five consecutive runs.

2. Effect of Sacrificial Oxidant.

To determine the effect of the concentration of sacrificial oxidant on the water oxidation reaction, the ratio of sacrificial oxidant to Complex 2_TiO₂ hybrid catalyst was varied (Exps. 5, 7 and 8, Table 2). In Exps. 7 and 8 of Table 2, the NaIO₄, the sacrificial oxidant was added in a two additions. From the data in Table 2, it was concluded that Complex 2_TiO₂ had a long lasting performance.

3. Leaching of Complex 2_TiO₂ Hybrid Catalyst.

The supernatant solution from Experiment 1, Table 2 showed no activity, indicating that no leaching occurs under these experimental conditions. To determine if the Complex 2 catalyst leached from the titanium dioxide catalyst after acid washing, the catalyst from Experiment 6, Table 2, was washed with 0.1 M HNO₃ and water, and isolated. Washing the catalyst with 0.1 M HNO₃ (Experiment 6, Table 2) resulted an appreciable loss in activity.

TABLE 2

| | | 2_TiO₂^{rut} | NaIO₄ | NaIO₄/Cat | TOF^{a} | TON | Oxygen |
|---|---|---|---|---|---|---|---|
| Exp. No. | Run | [g] | [10⁻⁵ mol] | [molar ratio] | [min⁻¹] | [cycles] | [10⁻⁵ mol] |
| 1 | I | 0.01242 | 5.0 | 471 | 2.8 | 200 | 2.13 (85%) |
| 2 | II | 0.01242 | 5.0 | 471 | 2.8 | 212 | 2.25 (90%) |
| 3 | III | 0.01242 | 5.0 | 471 | 2.4 | 202 | 2.15 (86%) |
| 4 | IV | 0.01242 | 5.0 | 471 | 2.1 | 215 | 2.28 (91%) |
| 5 | V | 0.01242 | 10.0 | 942 | 2.4 | 353 | 3.76 (75%) |
| 6 | VI^{b} | 0.01242 | 5.0 | 471 | 1.1 | 152 | 1.62 (65%) |
| 7 | I | 0.00153 | 5.0 | 3826 | 7.8 | 1593 | 2.08 (83%) |
| 8 | II | 0.00153 | 9.0 | 6887 | 7.2 | 2472 | 3.23 (72%) |

^{a}TOF value are calculated by linear regression of TON vs time plot in the 20-50 min region (linear trend).
^{b}Reaction performed after washing with 0.1M HNO₃ and water.

4. Metal-Doped Hybrid Catalyst.

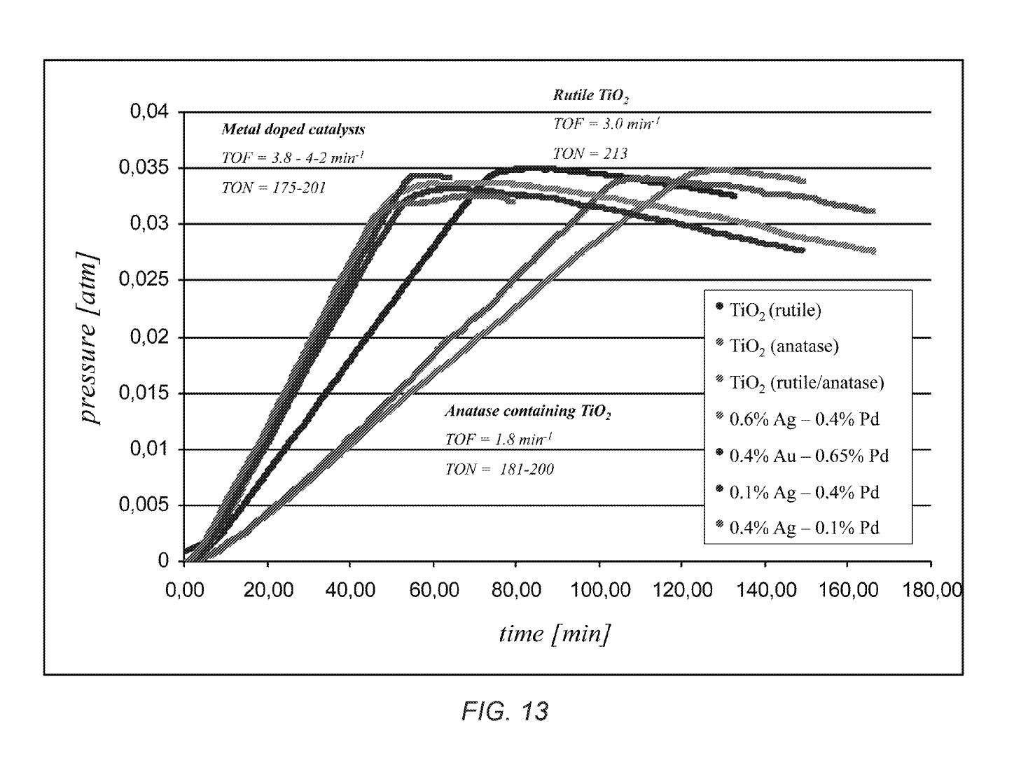

The catalyst from Example 3.2 were tested with sodium periodate as sacrificial oxidant using the procedure described in Example 3.1. Table 3 lists the catalyst, supported catalyst mass, the molar ratio of NaIO₄ to catalyst, turn over frequency, turn over number and amount of oxygen produced. FIG. 13 shows plots of oxygen pressure in atmosphere versus time in minutes for the Experiments in Table 3. From the data, the differences between pure and metal-doped titanium dioxide hybrid catalyst are small but appreciable. The metal-doped samples were considered to be more active (TOF up to 4.2 min⁻¹) than pure rutile/anatase (1.8 min⁻¹, their support). The TOF values were derived assuming that loading of catalyst on the different TiO2 samples was equal to the one measured (by ICP-OES analysis) for Complex 2 rutile TiO₂ hybrid catalyst.

TABLE 3

| | Supported | | | | | |
|---|---|---|---|---|---|---|
| | Catalyst | NaIO₄ | NaIO₄/Cat | TOF ^{b} | TON ^{c} | Oxygen |
| Catalyst | mass [g] | [10⁻⁵ mol] | [molar ratio] | [min⁻¹] | [cycles] | [10⁻⁵ mol] |
| TiO₂ (rutile) | 0.01340 | 5.0 | 437 | 3.0 | 213 | 2.26 (90%) |
| TiO₂ (anatase) | 0.01320 | 5.0 | 444 | 1.8 | 200 | 2.25 (90%) |
| TiO₂ (rutile/anatase) | 0.01340 | 5.0 | 437 | 1.8 | 181 | 2.05 (82%) |
| Ag 0.4%—Pd 0.1% ^{a} | 0.01379 | 5.0 | 425 | 4.1 | 175 | 2.07 (83%) |
| Ag 0.1%—Pd 0.4% ^{a} | 0.01340 | 5.0 | 437 | 3.8 | 184 | 2.13 (85%) |
| Ag 0.6%—Pd 0.4% ^{a} | 0.01342 | 5.0 | 436 | 4.2 | 189 | 2.17 (87%) |
| Au 0.4%—Pd 0.65% ^{a} | 0.01385 | 5.0 | 423 | 4.1 | 201 | 2.23 (89%) |

^{a} All metal doped catalyst are supported on rutile/anatase TiO₂.
^{b} TOF value are calculated by linear regression of TON vs time plot in the region 20-40 minutes (linear trend).
^{c} Assuming a catalyst loading on titanium dioxide 8.54 × 10⁻⁶ mol/g.

### Example 7

### Photo-Oxidation of Water Using [Ru(bipy)]²⁺/Na₂S₂O₈ in the Presence of the Complex 2

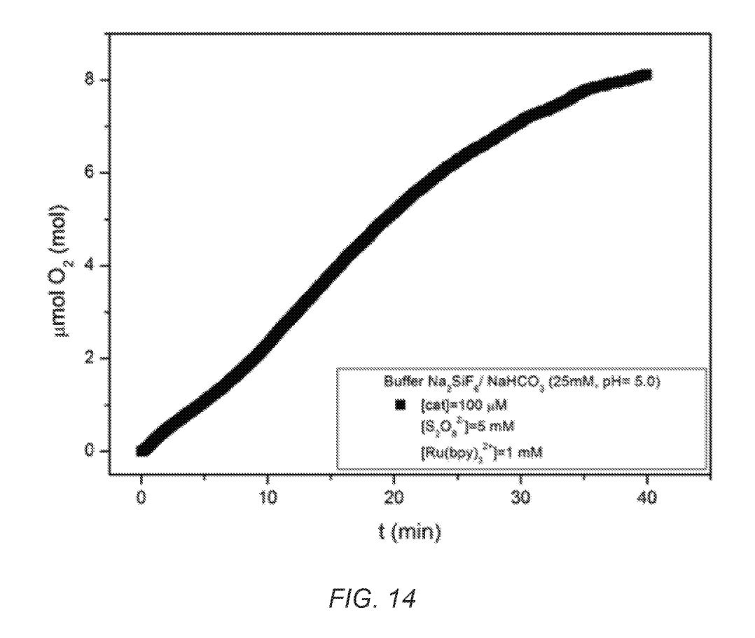

Water oxidation experiments were performed at pH 5 (by 25 mM NaHCO₃/Na₂SiF₆ aqueous buffer). Gas production was monitored through differential manometric measurements performed with a Testo 521-1 manometer. In a typical experiment 5 mL of a buffered solution containing [Ru(bpy)₃]Cl₂.6H₂O (1 mM), Na₂S₂O₈ (5 mM) and Complex 2 (100 μM) were transferred into the working cell, whereas the 5 mL of buffer solution were transferred into the reference cell; both cells, equipped with a side arm for the connection to the manometer and having a septum for the injection of solutions, were maintained under stirring. Both tubes were closed with a septum and connected to the manometer. The system was kept at a constant temperature of 25° C. and allowed to equilibrate for 15-30 min, monitoring the differential pressure. When a steady baseline was achieved, a light source (150 W halogen lamp), irradiating both cells, was turned on. Gas evolution started and was monitored by measuring the differential pressure between the two cells. Chemical and quantum yields, estimated by the measured production of O₂ compared with that expected considering the amount of used S₂O₈ and by having evaluated the photons per second per cm² by means of a physical actinometer, were 65% and 27%, respectively. FIG. 14 shows a plot of moles of produced oxygen versus time in minutes for the above-discussed experiment.

### Example 8

### Photo-Oxidation of Water Using [Ru(bipy)]²⁺/Na₂S₂O₈ in the Presence of the Hybrid Catalyst

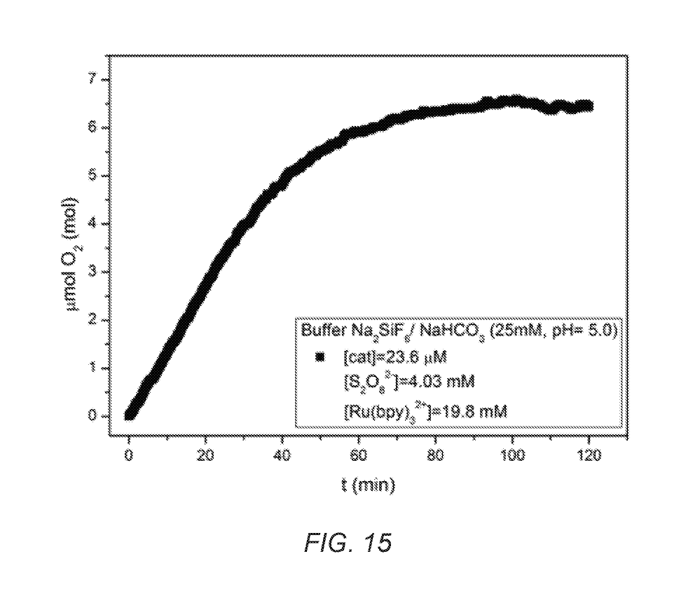

Water oxidation experiments were performed at pH 5 (by 25 mM NaHCO₃/Na₂SiF₆ aqueous buffer). Gas production was monitored through differential manometric measurements performed with a Testo 521-1 manometer. In a typical experiment 5 mL of a buffered solution containing [Ru(bpy)₃]Cl₂.6H₂O (1 mM), Na₂S₂O₈ (5 mM) and 0.0138 g of solid supported Complex 2 TiO₂ (loading of 8.54·10⁻⁶ mol/g, corresponding to 23 μM of catalyst) were transferred into the working cell, whereas the 5 mL of buffer solution were transferred into the reference cell; both cells, equipped with a side arm for the connection to the manometer and having a septum for the injection of solutions, were maintained under stirring. Both tubes were closed with a septum and connected to the manometer. The system was kept at a constant temperature of 25° C. and allowed to equilibrate for 15-30 min, monitoring the differential pressure. When a steady baseline was achieved, a light source (150 W halogen lamp), irradiating both cells, was turned on. Gas evolution started and was monitored by measuring the differential pressure between the two cells. Chemical and quantum yields, estimated by the measured production of O₂ compared with that expected considering the amount of used S₂O₈ and by having evaluated the photons per second per cm² by means of a physical actinometer, were 65% and 11%, respectively. FIG. 15 shows a plot of moles of produced oxygen versus time in minutes for the above-discussed experiment.

### Example 9

### Effect of Base on Water Oxidation in the Presence of the Complex 2

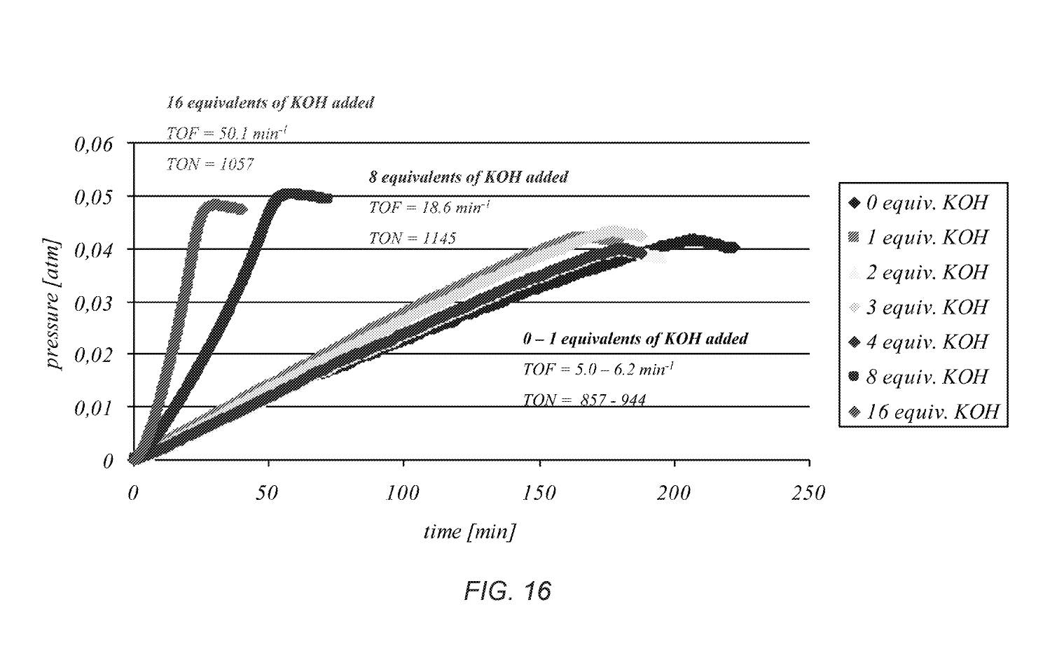

Complex 2, sacrificial oxidant and various equivalents base were subjected to the water oxidation conditions described in Example 4 to evaluate the effect of different equivalents of base (KOH) on the homogenous catalysis of oxygen production from the oxidation of water. Table 4 lists the equivalents of KOH, the concentration of the Complex 2 catalyst, the molar ratio of NaIO₄ to catalyst, turn over frequency, turn over number and amount of oxygen produced. FIG. 16 shows plots of oxygen pressure in atmosphere versus time in minutes for the experiments in Table 4. From the data, it was determined that, adding up to four equivalents of KOH, did not change the performance of the catalyst. The addition of larger amounts of KOH (8 and 16 equivalents) caused an increase in the activity of the Complex 2 catalyst up to one order of magnitude (TOF=50.1 min⁻¹). The pH of the reaction medium with the highest amount of KOH (16 equivalents) was found to be close to the neutral (pH=7.2). This was due to the concentration of the catalyst (and of the eventual KOH excess) in the catalytic solution is in the order of 10⁻⁶ M.

TABLE 4

| KOH | NaIO₄ | NaIO₄/Cat | TOF ^{a} | TON | Oxygen |
|---|---|---|---|---|---|
| equivalents | [10⁻⁵ mol] | [molar ratio] | [min⁻¹] | [cycles] | [10⁻⁵ mol] |
| 0 | 5 | 2025 | 5.0 | 878 | 2.2 (87%) |
| 1 | 5 | 2047 | 6.1 | 912 | 2.1 (84%) |
| 2 | 5 | 2069 | 5.3 | 857 | 2.2 (87%) |
| 3 | 5 | 2092 | 6.2 | 944 | 2.2 (87%) |
| 4 | 5 | 2182 | 5.3 | 858 | 2.1 (84%) |
| 8 | 5 | 2183 | 18.6^{b} | 1145 | 2.5 (100%) |
| 16 | 5 | 2002 | 50.1^{b} | 1097 | 2.5 (100%) |

^{a} TOF value are calculated by linear regression of TON vs time plot in the region 20-50 minutes (linear trend).
^{b}TOF value are calculated by linear regression of TON vs time plot in the region 10-20 minutes (linear trend).

### Example 10

### Effect of Base on Water Oxidation in the Presence of the Complex 2_TiO₂

Various Base Equivalents.

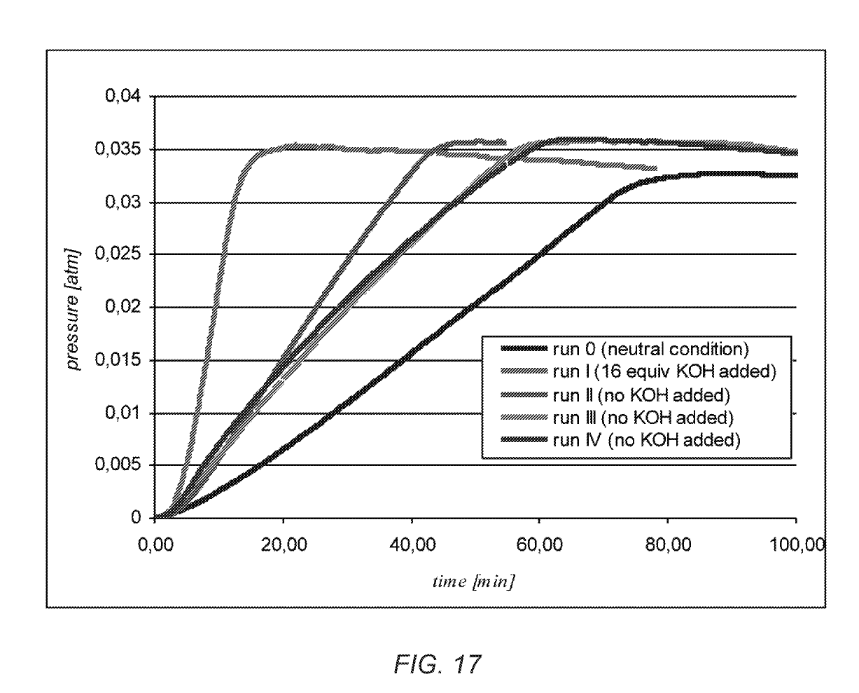

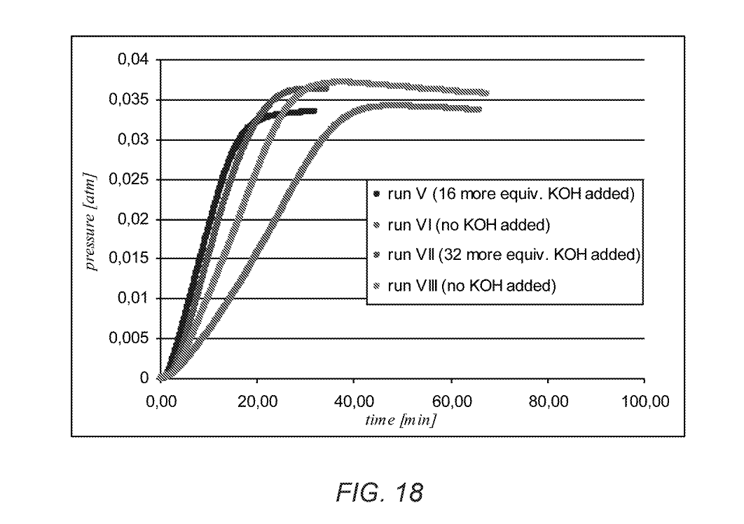

Complex 2 TiO₂ hybrid catalyst, sacrificial oxidant and various equivalents of base were subjected to the water oxidation conditions described in Example 4 to evaluate the effect of different equivalents of base (KOH) on the heterogeneous catalysis of oxygen production from the oxidation of water. In these experiments, the proper amount of KOH has been added to the catalyst before the injection of the sacrificial oxidant. Table 5 lists the equivalents of KOH, the concentration of the Complex 2 catalyst, the molar ratio of NaIO₄ to catalyst, turn over frequency, turn over number and amount of oxygen produced. FIGS. 17 and 18 are plots oxygen pressure in atmosphere versus time in minutes for the experiments in Table 5. From analysis of the data, it was determined that the addition of 16 equivalents of KOH led to a seven folds increase in TOF (run I, Table 5). Runs II-IV in Table 5 were performed in the absence base. From analysis of the data, it was determined that the activity of the catalyst in runs II-IV tended to decrease, until it stabilized at a TOF value of 3.5-3.8 min⁻¹, in any case higher that in the original condition (TOF 2.8 min⁻¹), run 0.

TABLE 5

| | | Supported | | | | | |
|---|---|---|---|---|---|---|---|
| | | Catalyst | NaIO₄ | NaIO₄/Cat | TOF ^{a} | TON ^{b} | Oxygen |
| Catalytic Run | Description of Run | mass [g] | [10⁻⁵ mol] | [molar ratio] | [min⁻¹] | [cycles] | [10⁻⁵ mol] |
| 0 | neutral condition | 0.01242 | 5.0 | 471 | 2.8 | 200 | 2.12 (84.9%) |
| I | 16 equiv. of KOH | 0.01230 | 5.0 | 476 | 19.8 | 218 | 2.29 (91.6%) |
| II | no KOH | 0.01230 | 5.0 | 476 | 5.8 | 220 | 2.31 (92.4%) |
| III | no KOH | 0.01230 | 5.0 | 476 | 3.8 | 221 | 2.32 (92.9%) |
| IV | no KOH | 0.01230 | 5.0 | 476 | 3.5 | 222 | 2.34 (93.6%) |
| V | 16 equiv. of KOH | 0.01230 | 5.0 | 476 | 14.0 | 212 | 2.23 (89.1%) |
| VI | no KOH^{c} | 0.01230 | 5.0 | 476 | 4.6 | 204 | 2.17 (85.7%) |
| VII | 32 equiv. of KOH ^{d} | 0.01230 | 5.0 | 476 | 12.3 | 209 | 2.20 (87.8%) |
| VIII | no KOH | 0.01230 | 5.0 | 476 | 8.8 | 224 | 2.35 (94.1%) |
| IX | after 24 h at pH 10 | 0.01230 | 5.0 | 476 | 5.7 | 215 | 2.26 (90.3%) |
| IXₛᵤₚₑᵣₙₐₗ | supernatant solution | n.a. | 5.0 | n.a. | n.a. | n.a. | no oxygen |
| | after 24 h at pH 10 | | | | | | production |
| X | after 20 h at pH 14 | 0.01230 | 5.0 | 476 | 5.3 | 216 | 2.27 (90.8%) |
| Xₛᵤₚₑᵣₙₐₜ | supernatant solution | n.a. | 5.0 | n.a. | n.a. | n.a. | slight oxygen |
| | after 24 h at pH 10 | | | | | | production |

^{a} TOF value are calculated by linear regression of TON vs time plot in the region of linear trend.
^{b} Considering a catalyst loading on titanium dioxide 8.54 × 10⁻⁶ mol/g as measured by ICP-OES analysis.
^{c}NaIO4 directly added into the cell after completion of run V.
^{d} KOH and NaIO4 directly added into the cell after completion of run VI.

2. Effect of Additional Base to a Reaction Mixture.

Further catalytic runs were performed with the same batch of catalyst (Run IV) by the addition of base after the completion of runs IV and run VI in Table 5. NaIO₄ was directly added into the reaction mixture after the completion of run V. From analysis of the data (FIG. 18), the effect of the base on the catalyst activity was determined to be reproducible. The addition of 17 more equivalents of KOH increased the TOF up to 14.0 min⁻¹ whereas the subsequent addition of 32 equivalents did not increase it.

3. pH of Solutions.

The pH of the solution was measured during the catalytic runs. Table 6 lists the pH of analyzed solutions. The addition of the Complex 2 TiO₂ hybrid catalyst to deionized water decreased the pH from 6.90 to 4.51. After the introduction of 17 μL of 0.1 M KOH (16 equivalents with respect to Complex 2) the pH increased to 9.60. Subsequently, the pH decreased to 6.32 when NaIO₄ was added. Without wishing to be bound by theory, the decrease in pH upon addition of NaIO₄ is believed to be due to the fact that IO₄⁻ (meta-periodate) undergoes hydration with two water molecules leading to the week acid H₄IO₆⁻, which has a Ka=4.9×10⁻⁹.

TABLE 6

| Analyzed solution | Measured pH |
|---|---|
| deionized water | 6.90 |
| after addition of 0.01210 g of | 4.51 |
| Complex 2_TiO₂ | |
| after further addition of 17 μL | 9.60 |
| of 0.1M KOH | |
| after further addition of 500 μL | 6.32 |
| of 0.1M NaIO₄ | |

### Example 11

### Water Oxidation in Buffered Solution with Complex 2

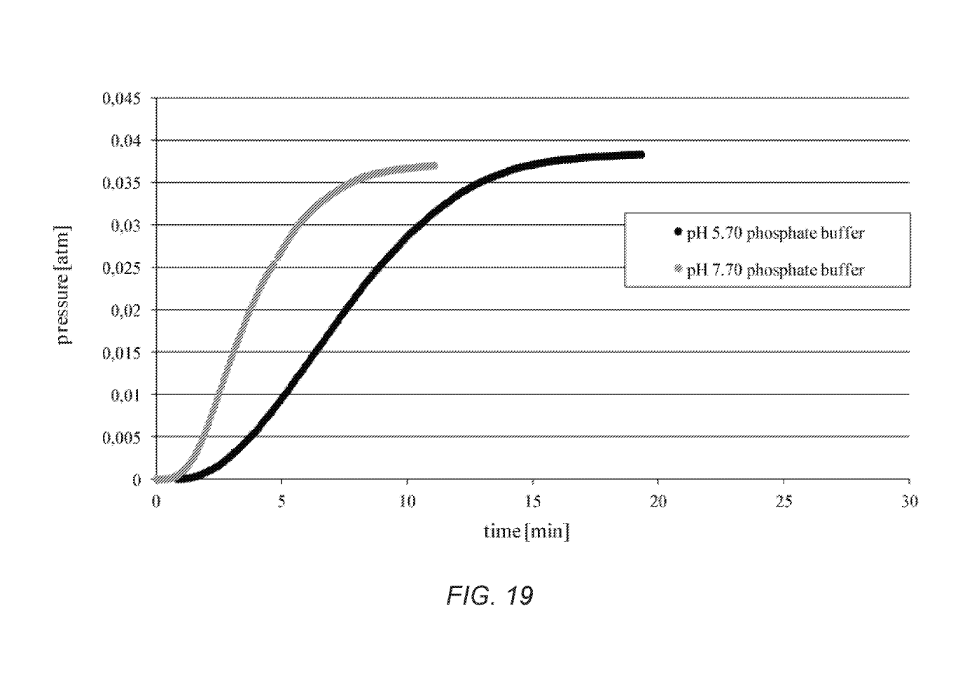

Water oxidation experiments were performed at pH 5.7 and 7.7 (by 0.2 M NaH₂PO₄/0.2 M Na₂HPO₄ buffer solutions). Gas production was monitored through differential manometric measurements performed with a Testo 521-1 manometer. In a typical experiment 4.950 mL of Complex 2 in a buffered solution (proper concentration in order to obtain the desired final concentration) and of a buffer solution were transferred in a homemade glass tube (working cell) and into another identical glass tube (reference cell), respectively; both cells, equipped with a side arm for the connection to the manometer and having a septum for the injection of solutions, were maintained under stirring. Both tubes were closed with a septum and connected to the manometer. The system was kept at a constant temperature of 25° C. and allowed to equilibrate for 15-30 min, monitoring the differential pressure. When a steady baseline was achieved, 50 μL of a 100 mM NaIO₄ buffered solution and buffer solution were injected into the working (final catalyst concentration=10 mM) and reference cells, respectively. Gas evolution was monitored by measuring the differential pressure between the two cells. Table 1 lists the catalyst used, the concentration of the complex, the concentration of NaIO₄, turn over frequency, turnover number and oxygen produced. FIG. 19 shows the effect of changing the pH (Exps 1 and 3 of Table 7) in the production of oxygen using Complex 2. From the analysis of data it is clear that TOF at pH 7.7 is more than two times higher than that at 5.7.

TABLE 7

| | C_{Cat} | C_{NaIO4} | TOF | | |
|---|---|---|---|---|---|
| Entry | (μM) | (mM) | (min⁻¹) | TON | O₂ yield |
| Complex 2 | pH = 5.7 | | | | |
| 1 | 10.0 | 10.0 | 54.0 | 504 | 100% |
| 2 | 5.0 | 10.0 | 55.4 | 977 | 98% |
| | pH = 7.7 | | | | |
| 3 | 10.0 | 10.0 | 113.8 | 495 | 99% |
| 4 | 5.0 | 10.0 | 142.9 | 1004 | 100% |
| 5 | 1.0 | 10.0 | 153.4 | 4553 | 91% |
| 6 I | 10.0 | 10.0 | 107.2 | 494 | 99% |
| 7 II | 9.5 | 9.5 | 63.3 | 495 | 99% |
| 8 III | 9.1 | 9.1 | 35.5 | 513 | 100% |
| 9 IV | 8.7 | 8.7 | 28.8 | 453 | 91% |
| 10 I | 1.0 | 10.0 | 143.4 | 4627 | 93% |
| 11 II | 0.95 | 9.5 | 109.6 | 4069 | 81% |
| 12 III | 0.91 | 9.1 | 96.1 | 3996 | 81% |
| Complex 2_TiO₂ | pH = 5.7 | | | | |
| 13 | 10.0 | 10.0 | 30.8 | 476 | 95% |
| 14 | 9.5 | 9.5 | 30.8 | 472 | 95% |
| | pH = 7.7 | | | | |
| 15 I | 10.0 | 10.0 | 82.1 | 483 | 97% |
| 16 II | 9.5 | 9.5 | 64.7 | 484 | 97% |
| 17 III | 9.1 | 9.1 | 52.3 | 498 | 100% |
| 18 IV | 8.7 | 8.7 | 39.7 | 449 | 90% |
| 19 I | 1.0 | 10.0 | 90.4 | 4411 | 88% |
| 20 II | 0.95 | 9.5 | 73.7 | 3510 | 70% |

### Example 12

### Water Oxidation in Buffered Solution with Hybrid Catalyst

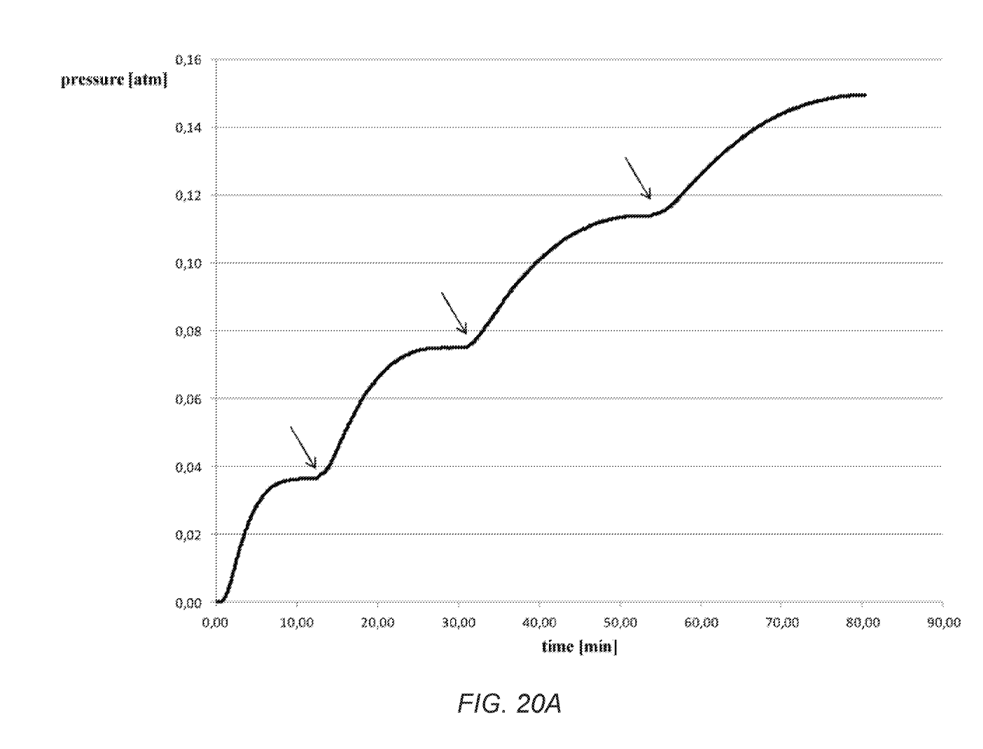

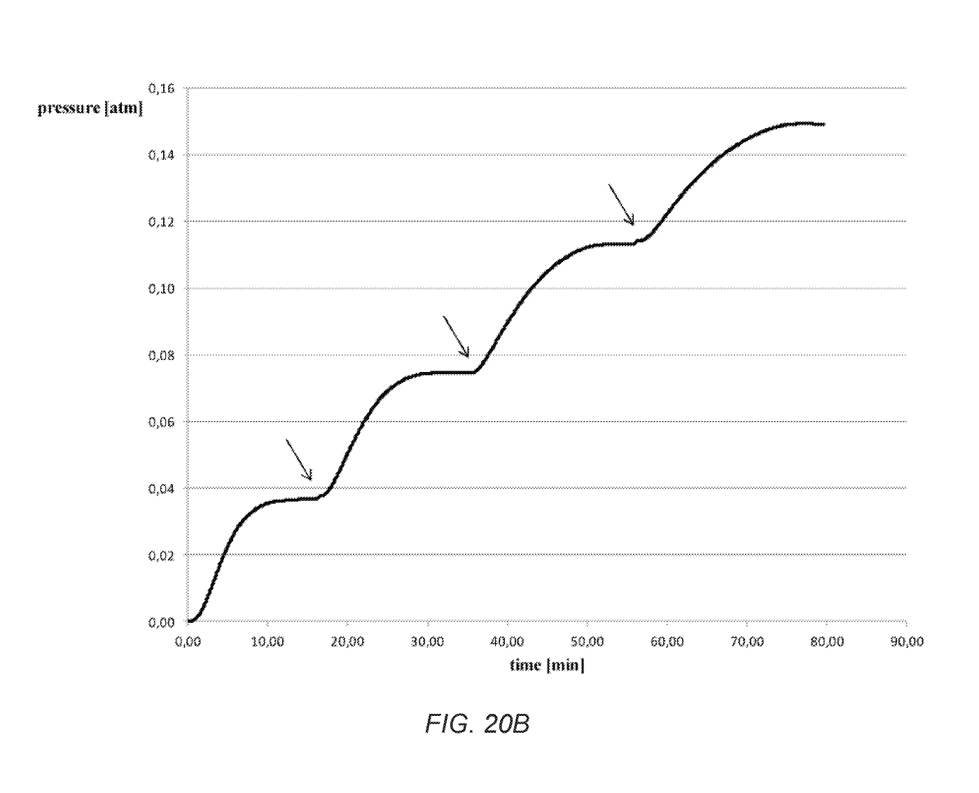

Water oxidation experiments were performed at pH 5.7 and 7.7 (by 0.2 M NaH₂PO₄/0.2 M Na₂HPO₄ buffer solutions). Gas production was monitored through differential manometric measurements performed with a Testo 521-1 manometer. In a typical experiment, the appropriate mass of hybrid catalyst was weighed directly into the working cell, whereas the reference cell was left empty. 4.950 mL of Complex 2_TiO₂ in a buffered solution (proper concentration in order to obtain the desired final concentration) and of a buffer solution were transferred into the working cell and into the reference cell, respectively. Both tubes were closed with a septum and connected to the manometer. The system was kept at a constant temperature of 25° C. and allowed to equilibrate for 15-30 min, monitoring the differential pressure. When a steady baseline was achieved, 50 μL it of a 100 mM NaIO₄ buffered solution and buffer solution were injected into the working (final catalyst concentration=10 mM) and reference cells, respectively. Gas evolution was monitored by measuring the differential pressure between the two cells. FIGS. 20A and 20B show a comparison of the production of oxygen using Complex 2 (20A, Exps 6-9 Table 7) and Complex 2_TiO₂ (20B, Exps 15-18 Table 7) as catalysts in multiple run experiments driven by NaIO₄. From the analysis of data it is clear that the hybrid catalyst is more robust than the organo-iridium one.

### Example 13

### Stability of Complex 2_TiO₂ Hybrid Catalyst at Basic and Acidic pH

1. Effect of pH 10 on Used Catalyst.

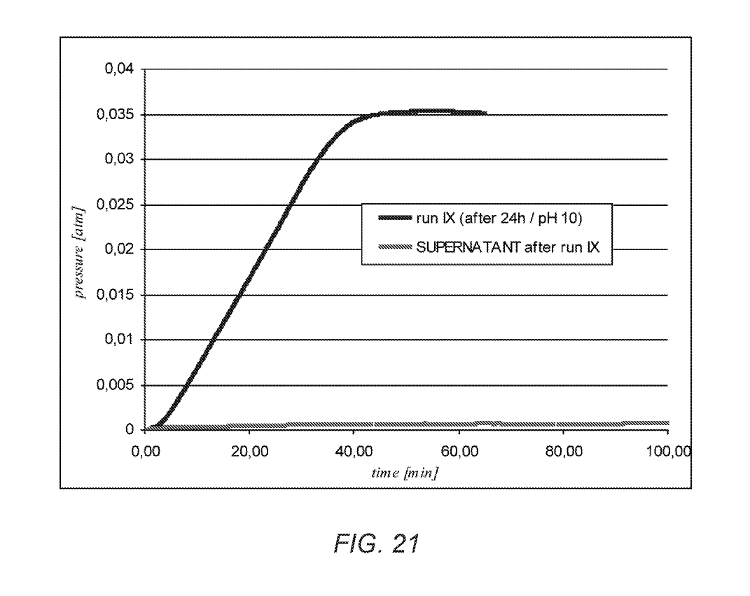

The Complex 2_TiO₂ hybrid catalyst from run VIII (Table 5), was left, under magnetic stirring, at pH 10.0 by KOH for 24 h. The base treated Complex 2_TiO₂ hybrid catalyst was then isolated, washed with water. The catalyst and obtained supernatant were tested using the water oxidation procedure of Example 4. (See, runs IX in Table 5). FIG. 21 shows plots of pressure in atm versus time for the base treated catalyst and the supernatant. From analysis of the data is was determined that the catalyst was still active and there was no sign of leaching of Complex 2 into the basic solution, demonstrated by the fact that the supernatant solution did not show any production of oxygen.

2. Effect of pH 14 on Used Catalyst.

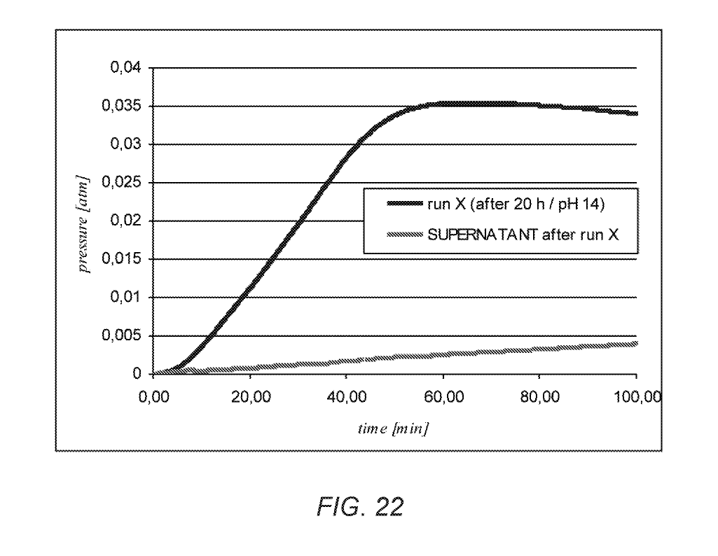

The Complex 2_TiO₂ hybrid catalyst from run IX was left, under magnetic stirring, at pH 14.0 by KOH for 20 h. The base treated Complex 2_TiO₂ hybrid catalyst was then isolated, washed twice with water. The catalyst and obtained supernatant were tested using the water oxidation procedure of Example 4 (See, runs X in Table 5). FIG. 22 shows plots of pressure in atm versus time for the base treated catalyst and the supernatant. From analysis of the data is was determined that the catalyst was still active and there was some sign of leaching of Complex 2 into the basic solution, demonstrated by the fact that the supernatant solution showed slight production of oxygen.

3. Effect of pH 14 on New Catalyst.

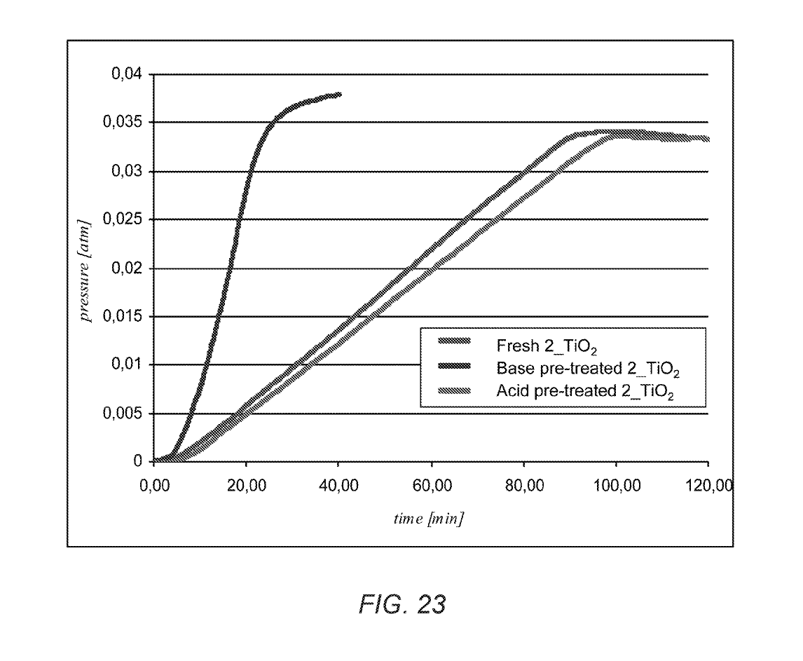

A Complex 2_TiO₂ hybrid catalyst made using the procedure in Example 2 was treated with aqueous base (KOH) at a pH of 14.0 for 20 h. The base treated Complex 2_TiO₂ hybrid catalyst was isolated from the aqueous mixture, washed twice with deionized water and then tested using the water oxidation procedure of Example 4. Table 8 lists the catalyst, supported catalyst mass, the molar ratio of NaIO₄ to catalyst, turn over frequency, turn over number and amount of oxygen produced. FIG. 23 shows plots of oxygen pressure in atmosphere versus time in minutes for Complex 2_TiO₂ hybrid catalyst, base treated Complex 2_TiO₂ hybrid catalyst, and acid treated Complex 2_TiO₂ hybrid catalyst. From analysis of the data, the base treated Complex 2_TiO₂ hybrid catalyst had activity similar to the used catalysts in Examples 9.1 and 9.2. Since the activity was similar, it was concluded that several catalytic runs do not modify the resistance of the catalyst toward leaching.

4. Effect of pH 1 on New Catalyst.

A Complex 2_TiO₂ hybrid catalyst made using the procedure in Example 2 was treated with aqueous acid (0.1 M HNO₃) at a pH of 1.0 for 24 h. The acid treated Complex 2_TiO₂ hybrid catalyst was isolated from the aqueous mixture, washed twice with deionized water and then tested using the water oxidation procedure of Example 6. From analysis of the data (Table 7, FIG. 19), it was determined that catalytic activity of the acid treated Complex 2_TiO₂ hybrid catalyst was substantially the same as that of the untreated Complex 2_TiO₂ hybrid catalyst (TOF 2.3 min⁻¹ compared to 2.4 min⁻¹ of the untreated catalyst).

TABLE 8

| | Supported | | | | | |
|---|---|---|---|---|---|---|
| | Catalyst | NaIO₄ | NaIO₄/Cat | TOF ^{a} | TON ^{c} | Oxygen |
| Catalytic run | mass [g] | [10⁻⁵ mol] | [molar ratio] | [min⁻¹] | [cycles] | [10⁻⁵ mol] |
| Complex 2_TiO₂ | 0.01234 | 5.0 | 500 | 2.4 | 210 | 2.29 (91.6%) |
| Base pre-treated | 0.01309 | 5.0 | 447 | 6.8^{b} | 220 | 2.46 (98.4%) |
| 2_TiO₂ (20 h/pH 14.0) | | | | | | |
| Acid pre-treated | 0.01280 | 5.0 | 457 | 2.3 | 206 | 2.25 (90.1%) |
| 2_TiO₂ (24 h/pH 1.0) | | | | | | |

^{a} TOF value are calculated by linear regression of TON vs time plot in the region 20-50 minutes (linear trend).
^{b}TOF value are calculated by linear regression of TON vs time plot in the region 4-10 minutes (linear trend).
^{c} Considering a catalyst loading on titanium dioxide 8.54 * 10⁻⁶ mol/g as measured by ICP-OES analysis.

1. A method for producing oxygen (O₂) and hydrogen (H₂) from water, the method comprising:
(a) obtaining a composition comprising:
(i) a hybrid catalyst comprising an organo-iridium catalyst deposited on the surface of a titanium dioxide catalyst; and
(ii) an aqueous solution having a buffer or having a base wherein the base is present in the aqueous solution in an amount at least 4 times equivalent with respect to the organo-iridium catalyst present on the hybrid catalyst; and
(b) exposing the composition to light to produce O₂ and H₂ from water molecules in the aqueous solution.

2. The method of claim 1, wherein the aqueous solution has a base present in the aqueous solution in an amount at 8 times to 20 times equivalent with respect to the organo-iridium catalyst present on the hybrid catalyst.

3. The method of claim 1, wherein the pH of the aqueous solution is 7 to 8.

4. The method of claim 1, wherein the aqueous solution does not include a sacrificial oxidant.

5. The method of claim 1, wherein the aqueous solution further comprises a sacrificial oxidant.

6. The method of claim 5, wherein the sacrificial oxidant is cerium ammonium nitrate (CAN), sodium periodate (NaIO₄), or sodium persulfate/ruthenium(II)-tris-2,2′-bipyridine (Na₂S₂O₈/[Ru(bipy)]²⁺).

7. The method of claim 1, wherein the hybrid catalyst is heterogeneously dispersed in the aqueous solution.

8. The method of claim 1, wherein the hybrid catalyst is partially or fully solubilized in the aqueous solution.

9. The method of claim 1, wherein the organo-iridium catalyst is a Klaüi-type compound.

10. The method of claim 9, wherein the Klaüi-type compound has the following structure: 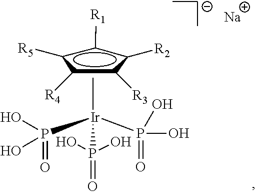
where R¹ to R⁵ the same or different and is H, or a C₁ to C₄ alkyl moieties or a combination thereof, preferably R¹ to R⁵ are methyl moieties.

11. The method of claim 10, wherein each of R¹ to R⁵ is CH₃.

12. The method of claim 1, wherein the titanium dioxide catalyst is a metal containing TiO₂ catalyst (metal/TiO₂), where the metal is silver (Ag), palladium (Pd), platinum (Pt), gold (Au), nickel (Ni), cobalt (Co), Rhodium (Rh), Ruthenium (Ru), Iridium (Ir), or copper (Cu) nanoparticles, or any combination thereof.

13. The method of claim 1, wherein the hybrid catalyst is in particulate form having a mean particle size of less than 100 nanometers (nm), less than 50 nm, less than 40 nm, less than 30 nm, less than 20 nm, or preferably, 5 to 30 nm, or most preferably 5 to 20 nm.

14. The method of claim 1, wherein the hybrid catalyst has a turnover number of 1000 to 3000 and a turnover frequency from 40 to 90 min⁻¹.

15. The method of claim 1, wherein the temperature of the composition in step (b) ranges from 10° C. to 70° C.

16. A hybrid catalyst comprising an organo-iridium catalyst deposited on the surface of a titanium dioxide catalyst, wherein the organo-iridium catalyst has the following structure: 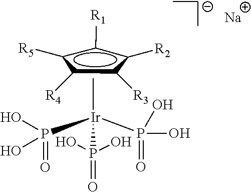
where R¹ to R⁵ are the same or different and are each individually H, or C₁ to C₄ alkyl moieties.

17. A composition capable of producing oxygen (O₂) and hydrogen (H₂) from water, the composition comprising:
(a) a hybrid catalyst comprising an organo-iridium catalyst deposited on the surface of a titanium dioxide catalyst; and
(b) an aqueous solution having a buffer or having a base wherein the base is present in the aqueous solution in an amount at least 4 times equivalent with respect to the organo-iridium catalyst present on the hybrid catalyst.

18. The composition of claim 17, wherein the aqueous solution has a base present in the aqueous solution in an amount at 8 times to 20 times equivalent with respect to the organo-iridium catalyst present on the hybrid catalyst.

19. The composition of claim 17, wherein the pH of the aqueous solution is 7 to 8.

20. The composition of claim 17, wherein the organo-iridium catalyst is a Klaüi-type compound having the following structure: 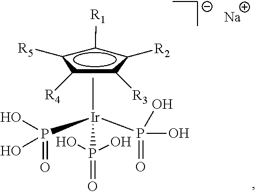
where R¹ to R⁵ are the same or different and are each individually H, or C₁ to C₄ alkyl moieties.
